(19) United States
(12) Patent Application Publication
(10) Pub. No.: US 2022/0021604 A1
(43) Pub. Date: Jan. 20, 2022

(54) INFORMATION PROCESSING SYSTEM, EDGE DEVICE, AND INFORMATION PROCESSING DEVICE

(71) Applicant: FUJITSU LIMITED, Kawasaki-shi (JP)

(72) Inventor: Shogo Asaba, Kawasaki (JP)

(73) Assignee: FUJITSU LIMITED, Kawasaki-shi (JP)

(21) Appl. No.: 17/229,909

(22) Filed: Apr. 14, 2021

(30) Foreign Application Priority Data
Jul. 20, 2020 (JP) 2020-123608

(51) Int. Cl. H04L 12/703; H04L 12/707; H04L 12/721; H04L 12/825

(52) U.S. Cl. CPC H04L 45/28; H04L 47/25; H04L 45/44; H04L 45/22

(57) ABSTRACT

An information processing system includes a plurality of edge devices including a first edge device and a second edge device and a plurality of information processing devices. The first edge device configure to transmit first data to a first information processing device, transmits second data to a second information processing device, and when detecting a failure of the first information processing device, transmit the first data to the second information processing device instead of the first information processing device. The second edge device configured to transmit a first amount of data to the second information processing device, transmit a second amount of data to a third information processing device, and when detecting that a total amount of the data transmitted to the second information processing device increases due to the failure, decrease the first amount and increase the second amount.

### CROSS-REFERENCE TO RELATED APPLICATION

This application is based upon and claims the benefit of priority of the prior Japanese Patent Application No. 2020-123608, filed on Jul. 20, 2020, the entire contents of which are incorporated herein by reference.

### FIELD

The embodiments discussed herein are related to an information processing system, an edge device, and an information processing device.

### BACKGROUND

Nowadays, with the progress of internet of things (IoT), information processing systems are used that collect and utilize data provided by various devices installed at edge sites such as factories, social infrastructures, and homes. Devices such as a sensor device or a client computer provided at an edge site may be referred to as an edge device or simply an edge. In such an information processing system, a large amount of data flowing from an edge site is processed by information processing devices in real time, and a function corresponding to a processing result may be provided to a user.

For example, there is a proposal for a software defined data center (SDDC) that processes a plurality of packets transmitted from an edge side by a plurality of virtual machines in a distributed manner. The proposed SDDC includes a software defined networking (SDN) controller and a plurality of edge switches. The SDN controller receives a service request packet of a user from an edge switch accessed by the user, and selects a target virtual machine from online virtual machines in a service cluster in accordance with a load distribution policy. The SDN controller determines forwarding information between the target virtual machine and the user. The SDN controller sends a first forwarding flow table based on the forwarding information to the edge switch of the target virtual machine, and sends a second forwarding flow table based on the forwarding information to the edge switch accessed by the user.

The related art is described in Japanese National Publication of International Patent Application No. 2018-504038.

### SUMMARY

According to an aspect of the embodiments, an information processing system includes a plurality of edge devices; and a plurality of information processing devices, wherein two or more information processing devices included in the plurality of information processing devices perform processing data acquired by each of the plurality of edge devices in a distributed manner, the plurality of edge devices includes: a first edge device configure to transmit first data to a first information processing device included in the plurality of information processing device, transmits second data to a second information processing device included in the plurality of information processing device, and when detecting a failure of the first information processing device, transmit the first data to the second information processing device instead of the first information processing device, and a second edge device configured to transmit a first amount of data to the second information processing device, transmit a second amount of data to a third information processing device included in the plurality of information processing device, and when detecting that a total amount of the data transmitted to the second information processing device increases due to the failure, decrease the first amount and increase the second amount.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram describing an information processing system according to a first embodiment;

FIG. 2 is a diagram describing an information processing system according to a second embodiment;

FIG. 3 is a diagram illustrating an example of hardware of an edge device;

FIG. 4 is a block diagram illustrating a function of an edge device and a function of an information processing device;

FIG. 5 is a diagram illustrating an example of bandwidth information;

FIG. 6 is a diagram illustrating an example of a normal state table;

FIG. 7 is a flowchart illustrating an example of normal state table creation processing;

FIG. 8 is a diagram illustrating an example of communication performance information;

FIG. 9 is a diagram illustrating an example of selection of possible transmission destinations of imaging data for an edge device;

FIG. 10 is a diagram illustrating an example of determination of a transmission destination group for an edge device;

FIG. 11 is a flowchart illustrating an example of operating state monitoring processing;

FIG. 12 is a flowchart illustrating an example of transmission table resynchronization processing;

FIG. 13 is a diagram illustrating an example of a corrected table;

FIG. 14 is a flowchart illustrating an example of corrected table correction processing;

FIG. 15 is a flowchart illustrating an example of correction plan creation processing;

FIG. 16 is a diagram illustrating an example of correction plan information;

FIG. 17 is a diagram (part 1) for describing correction of a corrected table;

FIG. 18 is a diagram (part 2) for describing correction of a corrected table;

FIG. 19 is a diagram for describing transition of the total amount of imaging data received by each information processing device;

FIG. 20 is a diagram describing a modification example of the information processing system according to the second embodiment;

FIG. 21 is a diagram (part 1) illustrating a specific example of application of the information processing system; and

FIG. 22 is a diagram (part 2) illustrating a specific example of application of the information processing system.

### DESCRIPTION OF EMBODIMENTS

In the related art, each of a plurality of edge devices may transmit data to a plurality of information processing devices in a distributed manner. However, when a certain information processing device goes down due to a failure, data may not be transmitted from an edge device to the information processing device. In this case, a possible idea may be to switch the transmission destination such that data scheduled to be transmitted from the edge device to the information processing device in which the failure has occurred is transmitted to another information processing device operating normally. However, the switching of the transmission destination may cause an increase in the amount of data received by the other information processing device as the switching destination, and an increase in the load on the other information processing device.

In one aspect, an object of the embodiments is to provide an information processing system, an edge device, and an information processing device that suppress concentration of the load.

Hereinafter, the embodiments will be described with reference to the drawings.

### First Embodiment

The first embodiment will be described.

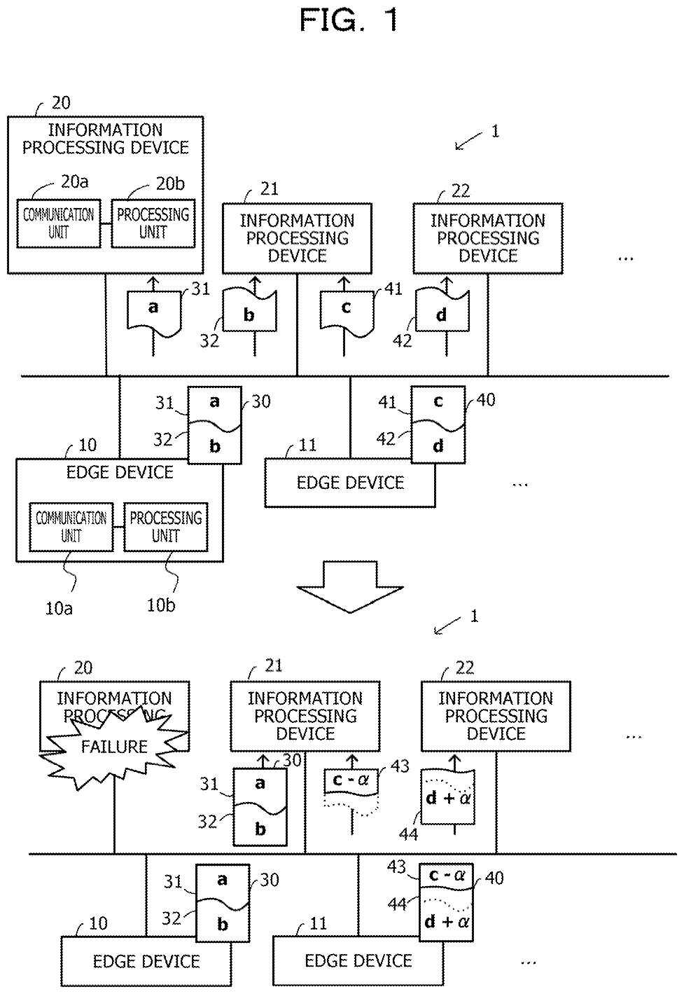

FIG. 1 is a diagram describing the information processing system according to the first embodiment.

An information processing system 1 includes a plurality of edge devices and a plurality of information processing devices. For example, the plurality of edge devices include edge devices 10, 11, . . . . The plurality of information processing devices include information processing devices 20, 21, 22, . . . . In the information processing system 1, two or more information processing devices among the information processing devices 20, 21, 22, . . . process, in a distributed manner, data 30, 40, . . . respectively acquired by the edge devices 10, 11, . . . .

Each of the edge devices 10, 11, . . . and the information processing devices 20, 21, 22, . . . may be realized by a computer including a memory and a processor that executes a program stored in the memory. For example, the memory may include a volatile memory such as a random-access memory (RAM) or a nonvolatile memory such as a hard disk drive (HDD) or a flash memory. In FIG. 1, however, illustration of the memory in each edge device and the memory in each information processing device is omitted.

Each of the edge devices 10, 11, . . . and the information processing devices 20, 21, 22, . . . includes a communication unit and a processing unit. For example, the edge device 10 includes a communication unit 10a and a processing unit 10b. The information processing device 20 includes a communication unit 20a and a processing unit 20b. The communication unit included in each edge device and the communication unit included in each information processing device are realized by, for example, a network interface card (NIC) that performs wired or wireless communication. The processing unit included in each edge device and the processing unit included in each information processing device are, for example, a central processing unit (CPU), a graphics processing unit (GPU), a digital signal processor (DSP), or the like. The processing unit may be a processor that executes a program. The processor may include a set of a plurality of processors (multiprocessor). Alternatively, the processing unit of each edge device and the processing unit of each information processing device may be realized by an electronic circuit such as a field-programmable gate array (FPGA) and an application-specific integrated circuit (ASIC).

The communication unit of each edge device (for example, the communication unit 10a) communicates with an information processing device that is a data transmission destination of the edge device. The processing unit of each edge device (for example, the processing unit 10b) executes information processing of the edge device described below. The communication unit of each information processing device (for example, the communication unit 20a) communicates with each edge device. For example, the communication unit of each information processing device receives data from an edge device that is a data transmission source. The processing unit of each information processing device (for example, the processing unit 20b) executes information processing of the information processing device described below. The edge devices 10, 11, . . . may be a communication control device that collects data acquired by a sensor device or the like an at edge site, and transmits the data to any information processing device.

First, description will be provided for the operation of the edge device 10 and the edge device 11 in a case where each information processing device is operating normally in the information processing system 1. Although a case where one edge device transmits data to two information processing devices is exemplified below, one edge device may transmit data to three or more information processing devices.

When each information processing device is operating normally, the edge device 10 transmits data 31 to the information processing device 20 and transmits data 32 to the information processing device 21, of the data 30 acquired by the edge device 10 in a predetermined period. For example, when an amount of data of the data 30 acquired in the predetermined period is “a+b”, the edge device 10 divides the data 30 into the data 31 having an amount of data “a” and the data 32 having an amount of data “b”. The edge device 10 transmits the data 31 to the information processing device 20 and transmits the data 32 to the information processing device 21. In this way, the edge device 10 causes the information processing device 20 and the information processing device 21 to process the data 31 and the data 32, respectively, in a distributed manner.

The edge device 11 transmits a first amount of data 41 to the information processing device 21 and transmits a second amount of data 42 to the information processing device 22, of data 40 acquired by the edge device 11 in a predetermined period. For example, when an amount of data of the data 40 acquired in the predetermined period is “c+d”, the edge device 11 divides the data 40 into the data 41 having an amount of data “c” and the data 42 having an amount of data “d”. The edge device 11 transmits the data 41 to the information processing device 21 and transmits the data 42 to the information processing device 22. In this way, the edge device 11 causes the information processing device 21 and the information processing device 22 to process the data 41 and the data 42, respectively, in a distributed manner.

Next, description will be provided for the operation of the edge devices 10 and 11 in a case where a failure occurs in the information processing device 20 in a state where each information processing device is operating normally in the information processing system 1.

The edge device 10 detects a failure of the information processing device 20. For example, the edge device 10 detects a failure of the information processing device 20 by detecting that there is no response to polling for the information processing device 20, that an error has occurred in transmission of the data 30, or other situations.

Upon detecting a failure of the information processing device 20, the edge device 10 transmits the data 31 whose transmission destination is the information processing device 20 to the information processing device 21 instead of the information processing device 20. In this way, the edge device 10 causes the information processing device 21 to process the data 31 (amount of data “a”) whose transmission destination was the information processing device 20.

The edge device 11 detects that the total amount of data transmitted to the information processing device 21 increases due to a failure of the information processing device 20. For example, the edge device 11 detects that the total amount of data transmitted to the information processing device 21 increases by receiving, from the information processing device 21, a notification indicating that the total amount of data has changed from “b+c” to “a+b+c”.

The edge device 11 decreases an amount of data transmitted to the information processing device 21, for example, the first amount, and increases an amount of data transmitted to the information processing device 22, for example, the second amount. For example, the edge device 11 sets data whose transmission destination is the information processing device 21 as data 43 obtained by decreasing an amount of data to “c−α” from the amount of data “c” of the data 41. The edge device 11 sets data whose transmission destination is the information processing device 22 as data 44 obtained by increasing an amount of data to “d+α” from the amount of data “d” of the data 42.

For example, it is considered that the edge device 11 makes the above-described adjustment of the amount of transmitted data in response to determination of a condition that the total amount of data received by the information processing device 21 is larger than a first threshold and the total amount of data received by the information processing device 22 is smaller than a second threshold. For example, in a case where the condition is satisfied, the edge device 11 decreases the amount of data transmitted to the information processing device 21 and increases the amount of data transmitted to the information processing device 22. On the other hand, the edge device 11 may be caused not to adjust the amount of transmitted data in a case where the condition is not satisfied. By taking the condition into consideration, if the processing performance of the information processing device 21 is relatively high enough, the process of adjusting the amount of transmitted data may be omitted, and an excessive increase in the total amount of data received by the information processing device 22 may be suppressed.

In this way, by adjusting the amount of data transmitted to the information processing devices 21 and 22, the edge device 11 reduces an increase in the total amount of data transmitted to the information processing device 21 due to the failure of the information processing device 20.

As described above, in the information processing system 1, the data 31 is transmitted from the edge device 10 to the information processing device 20, and the data 32 is transmitted from the edge device 10 to the information processing device 21. The first amount of data 41 is transmitted from the edge device 11 to the information processing device 21, and the second amount of data 42 is transmitted from the edge device 11 to the information processing device 22. By the edge device 10, a failure of the information processing device 20 is detected. The edge device 10 transmits the data 31 to the information processing device 21 instead of the information processing device 20. The edge device 11 detects that the total amount of data transmitted to the information processing device 21 increases due to a failure of the information processing device 20. The edge device 11 decreases the first amount and increases the second amount.

This may suppress concentration of the load on the information processing device 21.

When the total amount of data received by the information processing device 21 increases due to a failure of the information processing device 20, the information processing system 1 adjusts the amount of data transmitted from the edge device 11 to each information processing device, thereby reducing the increase in the total amount. For example, in the information processing system 1, an edge device that does not set an information processing device in which a failure has occurred as a data transmission destination adjusts the amount of data transmitted to each data transmission destination, thereby suppressing the total amount of data received by an information processing device that takes over the processing of the information processing device in which a failure has occurred. Accordingly, the information processing system 1 may suppress a situation where the total amount of data received by the information processing device that takes over the processing of the information processing device in which a failure has occurred becomes excessive and the real-time performance of the function provided to a user is impaired. As described above, according to the information processing system 1, a highly fault-tolerant system with improved availability may be realized while suppressing a processing delay in the information processing system 1.

The edge devices 10, 11, . . . may include another edge device that transmits a third amount of data to the information processing device 21 and transmits a fourth amount of data to an information processing device other than the information processing devices 20, 21, and 22 among the information processing devices 20, 21, 22, . . . . In this case, for example, when the total amount of data received by the information processing device 21, with the first amount decreased by the edge device 11, is larger than the first threshold and the total amount of data received by the other information processing device is smaller than a third threshold, the other edge device may decrease the third amount and increase the fourth amount. This may further suppress concentration of the load on the information processing device 21.

### Second Embodiment

Next, the second embodiment will be described.

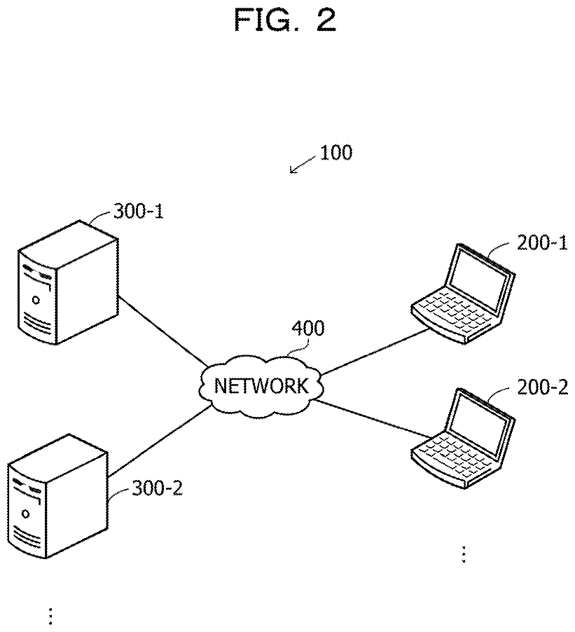

FIG. 2 is a diagram describing the information processing system according to the second embodiment. An information processing system 100 includes a plurality of edge devices and a plurality of information processing devices. The plurality of edge devices and the plurality of information processing devices are connected so as to communicate with each other via a network 400. For example, the plurality of edge devices include edge devices 200-1, 200-2, . . . . The plurality of information processing devices include information processing devices 300-1, 300-2, . . . . The information processing system 100 is a system in which two or more information processing devices among the information processing devices 300-1, 300-2, . . . process, in a distributed manner, pieces of data respectively acquired by the edge devices 200-1, 200-2, . . . .

The edge devices 200-1, 200-2, . . . are examples of the edge devices 10, 11, . . . of the first embodiment. The information processing devices 300-1, 300-2, . . . are examples of the information processing devices 20, 21, 22, . . . of the first embodiment. In the following description, an edge device 200 is used to indicate any edge device among the edge devices 200-1, 200-2, . . . . An information processing device 300 is used to indicate any information processing device among the information processing devices 300-1, 300-2, . . . .

Although a case where each edge device 200 divides data and transmits the divided data to two information processing devices 300 is exemplified below, the information processing system 100 may be configured such that each edge device 200 divides data and transmits the divided data to three or more information processing devices 300. Although a case where each edge device 200 acquires imaging data and each information processing device 300 performs analysis processing is exemplified below, data acquired by each edge device 200 may be data other than imaging data and processing performed by the information processing device 300 may be processing other than analysis processing.

The edge device 200 is a device that acquires and transmits imaging data. For example, the edge device 200 acquires imaging data from a camera (not illustrated). The edge device 200 divides the acquired imaging data and transmits the divided imaging data to each of two information processing devices 300 set as transmission destinations. The edge device 200 divides the acquired imaging data into two pieces of imaging data so as to enable analysis processing. For example, the edge device 200 divides the imaging data in units of frames (for example, divides imaging data of 60 frames into imaging data of even-numbered frames and imaging data of odd-numbered frames) or in units of pixels (for example, divides imaging data of 1,000,000 pixels into two pieces of imaging data of 500,000 pixels).

The information processing device 300 is a device that executes analysis processing on imaging data. For example, the information processing device 300 analyzes imaging data received from the edge device 200 by using an application. The information processing device 300 executes processing corresponding to an analysis result. The information processing device 300 performs machine learning by using imaging data as learning data, thereby improving analysis accuracy.

In the following description, it is assumed that imaging data acquired by the edge device 200 is 120 Mega bit per second (Mbps). In the following description, the information processing system 100 is described as including four information processing devices 300 (information processing devices 300-1 to 300-4) and 25 edge devices 200 (edge devices 200-1 to 200-25). The information processing system 100 may include a plurality of information processing devices 300 other than four or a plurality of edge devices 200 other than 25.

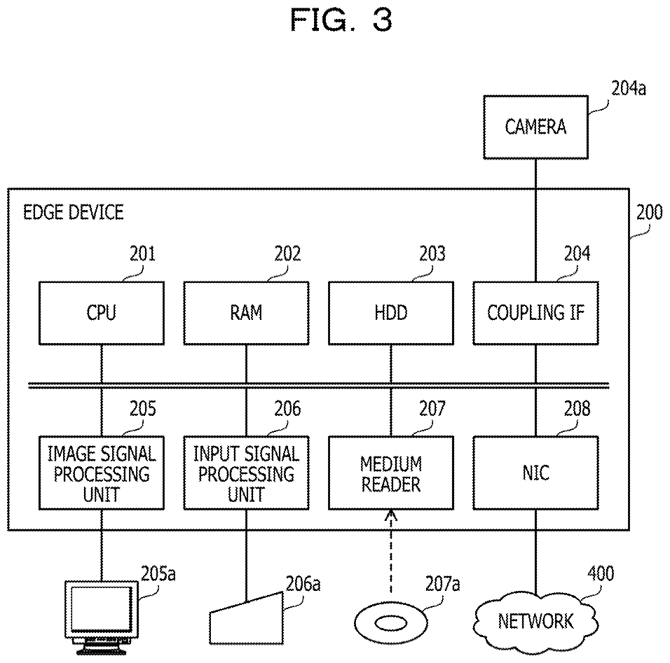

Next, hardware of the edge device 200 will be described. FIG. 3 is a diagram illustrating an example of hardware of an edge device.

The edge device 200 includes a CPU 201, a RAM 202, an HDD 203, a coupling interface (IF) 204, an image signal processing unit 205, an input signal processing unit 206, a medium reader 207 and a network interface card (NIC) 208. Each piece of hardware is coupled to a bus of the edge device 200. The CPU 201 is an example of the processing unit 10b of the first embodiment. The NIC 208 is an example of the communication unit 10a of the first embodiment.

The CPU 201 is a processor that executes a command of a program. The CPU 201 loads at least part of the program and data stored in the HDD 203 into the RAM 202, and executes the program. The CPU 201 may include a plurality of processor cores, and the edge device 200 may include a plurality of processors.

The RAM 202 is a main storage device of the edge device 200. The RAM 202 temporarily stores at least part of an operating system (OS) program and an application program executed by the CPU 201. The RAM 202 stores various kinds of data used for processing by the CPU 201.

The HDD 203 is an auxiliary storage device of the edge device 200. The HDD 203 magnetically writes and reads data to and from the built-in magnetic disk. The HDD 203 stores an OS program, an application program, and various kinds of data. The edge device 200 may include an auxiliary storage device of another kind such as a flash memory or a solid-state drive (SSD), and may include a plurality of auxiliary storage devices.

The coupling IF 204 couples peripheral devices. The coupling IF 204 acquires imaging data from a camera 204a coupled to the edge device 200 in accordance with a command from the CPU 201.

The image signal processing unit 205 outputs an image to a display 205a coupled to the edge device 200 in accordance with a command from the CPU 201. As the display 205a, a cathode ray tube (CRT) display, a liquid crystal display, or the like may be used.

The input signal processing unit 206 acquires an input signal from an input device 206a coupled to the edge device 200, and outputs the input signal to the CPU 201. As the input device 206a, for example, a pointing device such as a mouse or a touch panel, a keyboard, or the like may be used.

The medium reader 207 is a device that reads programs and data recorded in a recording medium 207a. As the recording medium 207a, for example, a magnetic disk such as a flexible disk (FD) or an HDD, an optical disk such as a compact disc (CD) or a Digital Versatile Disc (DVD), or a magneto-optical disc (MO) may be used. As the recording medium 207a, for example, a nonvolatile semiconductor memory such as a flash memory card may also be used. For example, the medium reader 207 stores, in accordance with a command from the CPU 201, programs and data read from the recording medium 207a in the RAM 202 or the HDD 203.

The NIC 208 performs communication with other devices via the network 400. The NIC 208 may be a wired communication interface or may be a wireless communication interface.

The edge device 200 may realize the processing function of the second embodiment with the hardware configuration described above. The information processing device 300 may be realized by using the same hardware as that of the edge device 200. The edge devices 10, 11, . . . and the information processing devices 20, 21, 22, . . . described in the first embodiment may be realized also by the same hardware as that of the edge device 200 illustrated in FIG. 3.

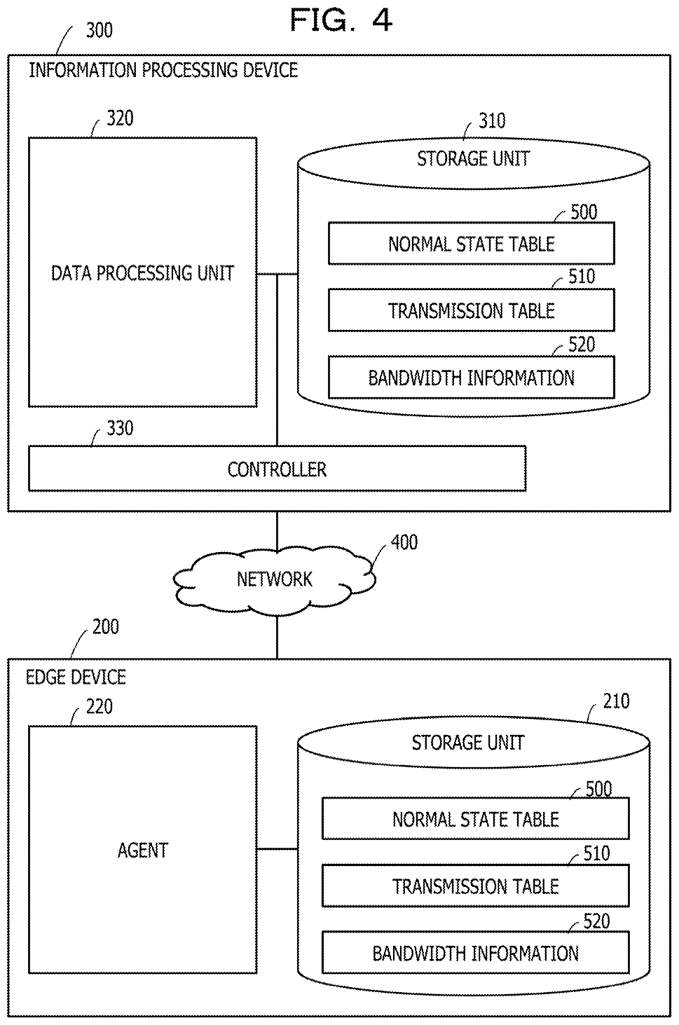

Next, a function of the edge device 200 and a function of the information processing device 300 will be described. FIG. 4 is a block diagram illustrating a function of an edge device and a function of an information processing device.

First, the edge device 200 will be described. The edge device 200 includes a storage unit 210 and an agent 220. A storage area of the RAM 202 or the HDD 203 is used for the storage unit 210. The agent 220 is realized by the CPU 201 executing the program stored in the RAM 202.

The storage unit 210 includes a normal state table 500, a transmission table 510, and bandwidth information 520.

The normal state table 500 is a table in which, in a state where each information processing device 300 is operating normally, an amount of imaging data transmitted from each edge device 200 to the information processing device 300 set as a transmission destination, is set.

The transmission table 510 is a table in which, in the current operating state of each information processing device 300, an amount of imaging data transmitted from each edge device 200 to the information processing device 300 set as a transmission destination, is set. The transmission table 510 is used to determine a transmission destination and an amount of imaging data transmitted to each transmission destination when the edge device 200 transmits imaging data to transmission destinations. The contents of the transmission table 510 are the same as those of the normal state table 500 when each information processing device 300 is operating normally.

The bandwidth information 520 is information on a network bandwidth of the information processing device 300.

The agent 220 controls the exchange of imaging data with the information processing device 300 (for example, a controller 330) set as a transmission destination. The agent 220 acquires imaging data, divides the acquired imaging data into two based on the transmission table 510, and transmits the divided imaging data to each transmission destination. The agent 220 monitors the operating state of each transmission destination, and when detecting a change in the operating state (for example, occurrence of a failure or recovery from a failure), performs processing of adjusting the amount of imaging data transmitted to each transmission destination (processing of correcting the transmission table 510). When the total amount of received imaging data exceeds a threshold in any transmission destination, the agent 220 performs processing of adjusting the amount of imaging data transmitted to each transmission destination (processing of correcting the transmission table 510).

Next, the information processing device 300 will be described. The information processing device 300 includes a storage unit 310, a data processing unit 320, and the controller 330.

A storage area of the RAM or the HDD of the information processing device 300 is used for the storage unit 310. The data processing unit 320 and the controller 330 are realized by the CPU executing a program stored in the RAM of the information processing device 300.

In the information processing system 100, the function of the controller 330 may be realized by an external device (for example, a communication device) coupled to the information processing device 300. In this case, in the information processing system 100, for example, some of the functions of the storage unit 310 described later are realized by a storage area of the memory or the HDD of the external device.

The storage unit 310 includes information (for example, an application or the like) used by the data processing unit 320 for analysis processing of imaging data. The storage unit 310 includes a normal state table 500, a transmission table 510, and bandwidth information 520.

The data processing unit 320 analyzes imaging data received from the edge device 200 (for example, the agent 220) by using an application. The data processing unit 320 executes processing corresponding to an analysis result. The data processing unit 320 performs machine learning by using imaging data as learning data, thereby improving analysis accuracy.

The controller 330 controls the exchange of imaging data with the edge device 200 (for example, the agent 220). When a change occurs in the operating state of the information processing device 300 other than the own device, the controller 330 performs processing of adjusting the amount of imaging data transmitted from each edge device 200 to each transmission destination (processing of correcting the transmission table 510). When the total amount of received imaging data exceeds a threshold in any information processing device 300, the controller 330 performs processing of adjusting the amount of imaging data transmitted from each edge device 200 to each transmission destination (processing of correcting the transmission table 510).

The controller 330 of any one of the plurality of information processing devices 300 included in the information processing system 100 includes a function as a master controller that performs processing of creating the normal state table 500 in addition to the above-described function.

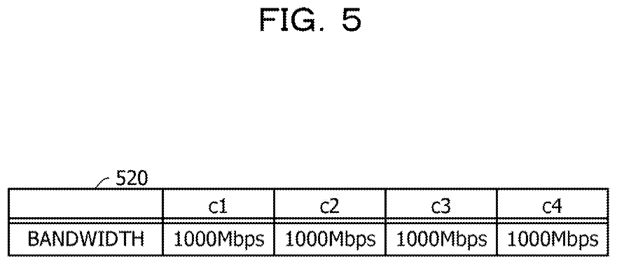

Next, the bandwidth information 520 will be described. FIG. 5 is a diagram illustrating an example of bandwidth information. In the following description, cn indicates the controller 330 of the information processing device 300-n (n=1, 2, 3, 4).

The bandwidth information 520 is information indicating a network bandwidth of each information processing device 300 (also referred to as each controller 330). The bandwidth information 520 is used as a threshold in adjusting the amount of imaging data transmitted from each edge device 200 to each transmission destination.

The bandwidth information 520 includes an item of the bandwidth of c1, an item of the bandwidth of c2, an item of the bandwidth of c3, and an item of the bandwidth of c4. For example, in the item of the bandwidth of c1, the item of the bandwidth of c2, the item of the bandwidth of c3, and the item of the bandwidth of c4 of the bandwidth information 520, the value of a bandwidth usable by each information processing device 300 to receive data from each edge device 200 is set. The value of a bandwidth is determined in advance, for example, in accordance with a contract between a business operator that provides a service and a line company.

In FIG. 5, in the bandwidth information 520, 1000 Mbps is set in the item of the bandwidth of c1 to indicate that the bandwidth of the information processing device 300-1, for which exchange of imaging data with the edge device 200 is controlled by c1, is 1000 Mbps. In the bandwidth information 520, 1000 Mbps is set in the item of the bandwidth of c2 to indicate that the bandwidth of the information processing device 300-2, for which exchange of imaging data with the edge device 200 is controlled by c2, is 1000 Mbps. In the bandwidth information 520, 1000 Mbps is set in the item of the bandwidth of c3 to indicate that the bandwidth of the information processing device 300-3, for which exchange of imaging data with the edge device 200 is controlled by c3, is 1000 Mbps. In the bandwidth information 520, 1000 Mbps is set in the item of the bandwidth of c4 to indicate that the bandwidth of the information processing device 300-4, for which exchange of imaging data with the edge device 200 is controlled by c4, is 1000 Mbps.

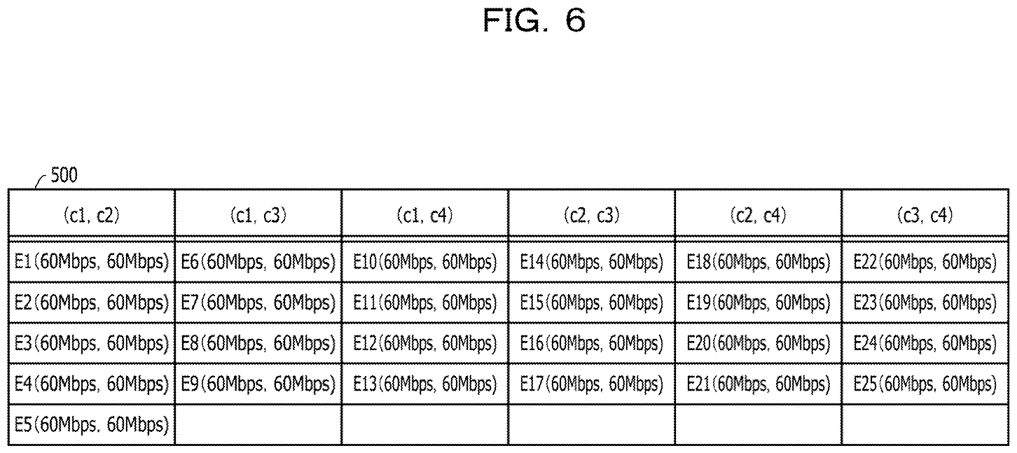

Next, the normal state table 500 (the transmission table 510 in the state where each information processing device 300 is operating normally) will be described. FIG. 6 is a diagram illustrating an example of a normal state table. In the following description, En indicates the edge device 200-n (n=1 to 25).

The normal state table 500 is a table in which, in the state where each information processing device 300 is operating normally, an amount of imaging data transmitted from each edge device 200 to the information processing device 300 set as a transmission destination, is set.

The normal state table 500 includes an item for each transmission destination group (also referred to as a transmission destination pair) that is a combination of two transmission destinations. For example, the normal state table 500 includes an item of (c1, c2), an item of (c1, c3), an item of (c1, c4), an item of (c2, c3), an item of (c2, c4), and an item of (c3, c4).

The item of (c1, c2) is an item in which information indicating the edge device 200 is set, the transmission destinations of imaging data of the edge device being the information processing device 300-1 for which exchange of imaging data is controlled by c1 and the information processing device 300-2 for which exchange of imaging data is controlled by c2. The item of (c1, c2) is an item in which, with respect to the edge devices 200 for which the transmission destinations are the information processing device 300-1 and the information processing device 300-2, an amount of imaging data transmitted to the information processing device 300-1 and an amount of imaging data transmitted to the information processing device 300-2 are set.

The item of (c1, c3) is an item in which information indicating the edge device 200 is set, the transmission destinations of imaging data of the edge device being the information processing device 300-1 for which exchange of imaging data is controlled by c1 and the information processing device 300-3 for which exchange of imaging data is controlled by c3. The item of (c1, c3) is an item in which, with respect to the edge devices 200 for which the transmission destinations are the information processing device 300-1 and the information processing device 300-3, an amount of imaging data transmitted to the information processing device 300-1 and an amount of imaging data transmitted to the information processing device 300-3 are set.

The item of (c1, c4) is an item in which information indicating the edge device 200 is set, the transmission destinations of imaging data of the edge device being the information processing device 300-1 for which exchange of imaging data is controlled by c1 and the information processing device 300-4 for which exchange of imaging data is controlled by c4. The item of (c1, c4) is an item in which, with respect to the edge devices 200 for which the transmission destinations are the information processing device 300-1 and the information processing device 300-4, an amount of imaging data transmitted to the information processing device 300-1 and an amount of imaging data transmitted to the information processing device 300-4 are set.

The item of (c2, c3) is an item in which information indicating the edge device 200 is set, the transmission destinations of imaging data of the edge device being the information processing device 300-2 for which exchange of imaging data is controlled by c2 and the information processing device 300-3 for which exchange of imaging data is controlled by c3. The item of (c2, c3) is an item in which, with respect to the edge devices 200 for which the transmission destinations are the information processing device 300-2 and the information processing device 300-3, an amount of imaging data transmitted to the information processing device 300-2 and an amount of imaging data transmitted to the information processing device 300-3 are set.

The item of (c2, c4) is an item in which information indicating the edge device 200 is set, the transmission destinations of imaging data of the edge device being the information processing device 300-2 for which exchange of imaging data is controlled by c2 and the information processing device 300-4 for which exchange of imaging data is controlled by c4. The item of (c2, c4) is an item in which, with respect to the edge devices 200 for which the transmission destinations are the information processing device 300-2 and the information processing device 300-4, an amount of imaging data transmitted to the information processing device 300-2 and an amount of imaging data transmitted to the information processing device 300-4 are set.

The item of (c3, c4) is an item in which information indicating the edge device 200 is set, the transmission destinations of imaging data of the edge device being the information processing device 300-3 for which exchange of imaging data is controlled by c3 and the information processing device 300-4 for which exchange of imaging data is controlled by c4. The item of (c3, c4) is an item in which, with respect to the edge devices 200 for which the transmission destinations are the information processing device 300-3 and the information processing device 300-4, an amount of imaging data transmitted to the information processing device 300-3 and an amount of imaging data transmitted to the information processing device 300-4 are set.

For example, in the normal state table 500 illustrated in FIG. 6, information of E3 (60 Mbps, 60 Mbps) is set in the item of (c1, c2). This indicates that the transmission destinations of imaging data of the edge device 200-3 are the information processing device 300-1 for which exchange of imaging data is controlled by c1 and the information processing device 300-2 for which exchange of imaging data is controlled by c2. It is indicated that the edge device 200-3 transmits imaging data of 60 Mbps to the information processing device 300-1 and transmits imaging data of 60 Mbps to the information processing device 300-2. For example, it is indicated that imaging data of 120 Mbps is divided into the imaging data of 60 Mbps and the imaging data of 60 Mbps (division at a ratio of 50:50).

In the normal state table 500, the transmission destinations and the amount of transmitted data of each edge device 200 are set such that the total amount of imaging data received by each information processing device 300 does not exceed the bandwidth of each information processing device 300. Accordingly, the information processing system 100 may suppress the occurrence of a processing delay in analysis processing caused by a delay in the reception of imaging data in each information processing device 300.

For example, in the normal state table 500 in FIG. 6, the information processing device 300-1, for which exchange of imaging data is controlled by c1, is set to receive imaging data of 60 Mbps from each of E1 to E13. Thus, the total amount of imaging data received by the information processing device 300-1 is 780 Mbps, which is equal to or less than the bandwidth (1000 Mbps) of the information processing device 300-1. The information processing device 300-2, for which exchange of imaging data is controlled by c2, is set to receive imaging data of 60 Mbps from each of E1 to E5 and E14 to E21. Thus, the total amount of imaging data received by the information processing device 300-2 is 780 Mbps, which is equal to or less than the bandwidth (1000 Mbps) of the information processing device 300-2.

The information processing device 300-3, for which exchange of imaging data is controlled by c3, is set to receive imaging data of 60 Mbps from each of E6 to E9, E14 to E17, and E22 to E25. Thus, the total amount of imaging data received by the information processing device 300-3 is 720 Mbps, which is equal to or less than the bandwidth (1000 Mbps) of the information processing device 300-3. The information processing device 300-4, for which exchange of imaging data is controlled by c4, is set to receive imaging data of 60 Mbps from each of E10 to E13 and E18 to E25. Thus, the total amount of imaging data received by the information processing device 300-4 is 720 Mbps, which is equal to or less than the bandwidth (1000 Mbps) of the information processing device 300-4.

In the normal state table 500 in FIG. 6, the numbers of edge devices 200 for the respective transmission destination groups, are substantially equal to each other (the range of difference is within one). Thus, in a case where a failure occurs in any one of the information processing devices 300, the information processing system 100 may cause a transmission destination for the edge device 200, for which the other transmission destination is the information processing device 300 in which the failure has occurred, to be different from those for other edge devices as much as possible.

In the normal state table 500 in FIG. 6, the amount of transmitted imaging data is set for each edge device 200 such that the amounts of imaging data transmitted to the transmission destinations included in the transmission destination group are equal to each other. This enables the information processing system 100 to secure room for adjustment (room for increase or decrease) of the amount of imaging data transmitted from each edge device 200 to each transmission destination.

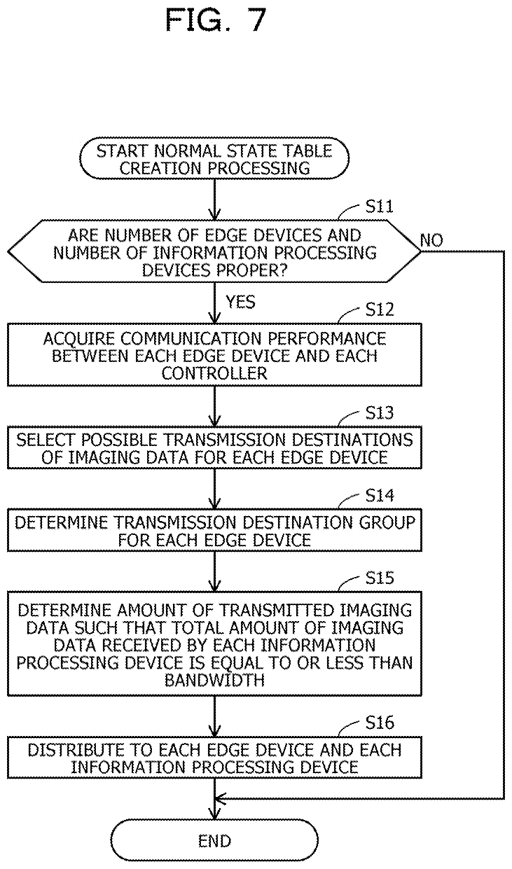

Next, processing of creating the normal state table 500 illustrated in FIG. 6 will be described. FIG. 7 is a flowchart illustrating an example of normal state table creation processing. Normal state table creation processing is processing performed by a master controller. For example, the master controller executes normal state table creation processing before the start of the operation of the information processing system 100.

[Step S11] The master controller determines whether the number of edge devices 200 and the number of information processing devices 300 included in the information processing system 100 are in a proper relationship. For example, the master controller determines that a relationship is proper when each information processing device 300 may receive imaging data from each edge device 200 without exceeding the bandwidth, even in a case where a failure has occurred in one of the plurality of information processing devices 300.

In one example, a proper relationship is determined when, in a state where a failure has occurred in any one of the information processing devices 300, a value obtained by summing up the bandwidths of the remaining information processing devices 300 is equal to or larger than a value obtained by summing up the amount of imaging data transmitted from each edge device 200.

In the information processing system 100, the bandwidth of each information processing device 300 is 1000 Mbps, and each edge device 200 transmits imaging data of 120 Mbps. Thus, the value obtained by summing up the bandwidths of the remaining information processing devices 300 in the state where a failure has occurred in any one of the information processing devices 300 is 1000×(4−1)=3000. On the other hand, the total amount of imaging data transmitted from each edge device 200 is 25×120=3000. For example, the value obtained by summing up the bandwidths of the remaining information processing devices 300 in the state where a failure has occurred in any one of the information processing devices 300 is equal to or larger than the total amount of imaging data transmitted from each edge device 200. Thus, the master controller determines that the number of edge devices 200 and the number of information processing devices 300 included in the information processing system 100 are in a proper relationship.

When determining that the number of edge devices 200 and the number of information processing devices 300 are in a proper relationship, the master controller proceeds to step S12. When determining that the numbers are not in a proper relationship, the master controller notifies a system manager that the numbers are not in a proper relationship and ends the normal state table creation processing.

[Step S12] The master controller acquires communication performance between each edge device 200 and each controller 330 (information processing device 300). The master controller causes each edge device 200 to measure communication performance between the own device and each controller 330, and collects an acquisition result from each edge device 200 to acquire communication performance between each edge device 200 and each controller 330.

For example, as communication performance, the master controller acquires information on latency and bandwidth between each edge device 200 and each controller 330. For example, the edge device 200 measures latency between the own device and each controller 330 by using a Ping command, and notifies the master controller of the measured latency. The edge device 200 measures a network bandwidth between the own device and each controller 330 by using an Iperf command, and notifies the master controller of the measured bandwidth. The edge device 200 may measure and notify of a communication amount instead of or in addition to a bandwidth. In this case, for example, the edge device 200 measures a communication amount between the own device and each controller 330 by using a netstat command, and notifies the master controller of the measured communication amount.

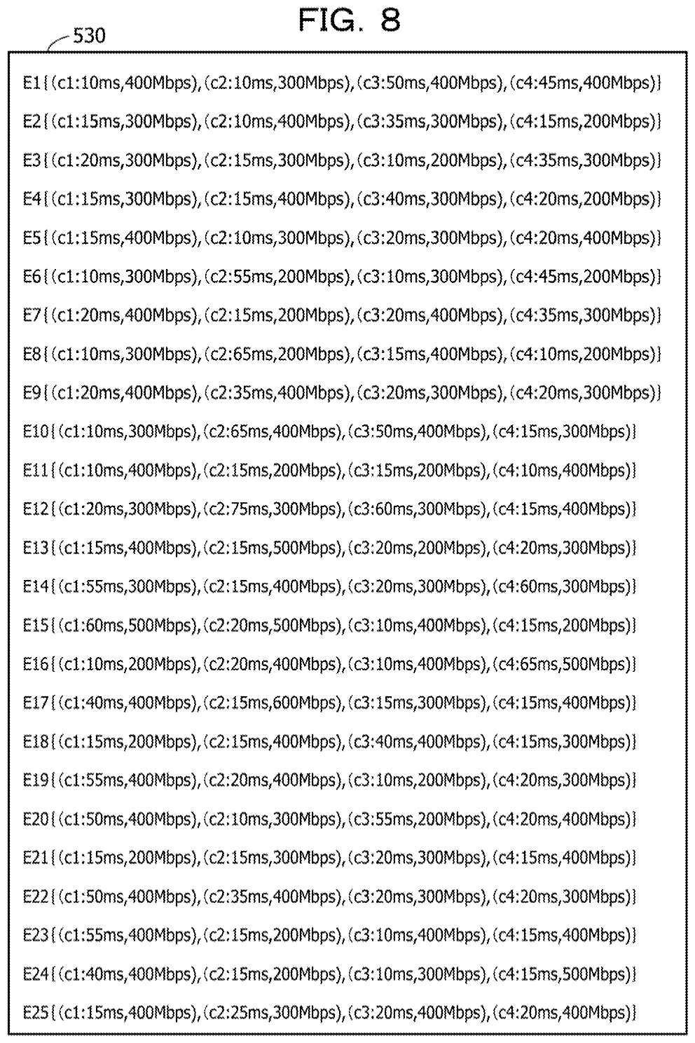

A specific example of communication performance acquired by the master controller will be described. FIG. 8 is a diagram illustrating an example of communication performance information.

Communication performance information 530 is listed information on communication performance between each edge device 200 and the controller 330 of each information processing device 300, acquired by the master controller from each edge device 200.

The communication performance information 530 includes (c1: 10 ms, 400 Mbps), (c2: 10 ms, 300 Mbps), (c3: 50 ms, 400 Mbps), and (c4: 45 ms, 400 Mbps) as the communication performance acquired from E1.

For example, the communication performance information 530 indicates that the latency between E1 and c1 is 10 ms and the bandwidth is 400 Mbps. The communication performance information 530 indicates that the latency between E1 and c2 is 10 ms and the bandwidth is 300 Mbps. The communication performance information 530 indicates that the latency between E1 and c3 is 50 ms and the bandwidth is 400 Mbps. The communication performance information 530 indicates that the latency between E1 and c4 is 45 ms and the bandwidth is 400 Mbps.

[Step S13] The master controller selects possible transmission destinations of imaging data for each edge device 200 based on the acquired communication performance between each edge device 200 and each controller 330 (information processing device 300). The master controller selects, as a possible transmission destination of imaging data for the edge device 200, the information processing device 300 for which exchange of imaging data is controlled by the controller 330 whose communication performance with the edge device 200 satisfies a preset criterion (threshold).

For example, the master controller selects, as a possible transmission destination for the edge device 200, the information processing device 300 for which exchange of imaging data is controlled by the controller 330 having latency between the edge device 200 and the controller of 20 ms or less and a bandwidth of 300 Mbps or more. When there are edge devices 200 for which two or more possible transmission destinations may not be selected, the master controller notifies the system manager of the existence and ends the normal state table creation processing.

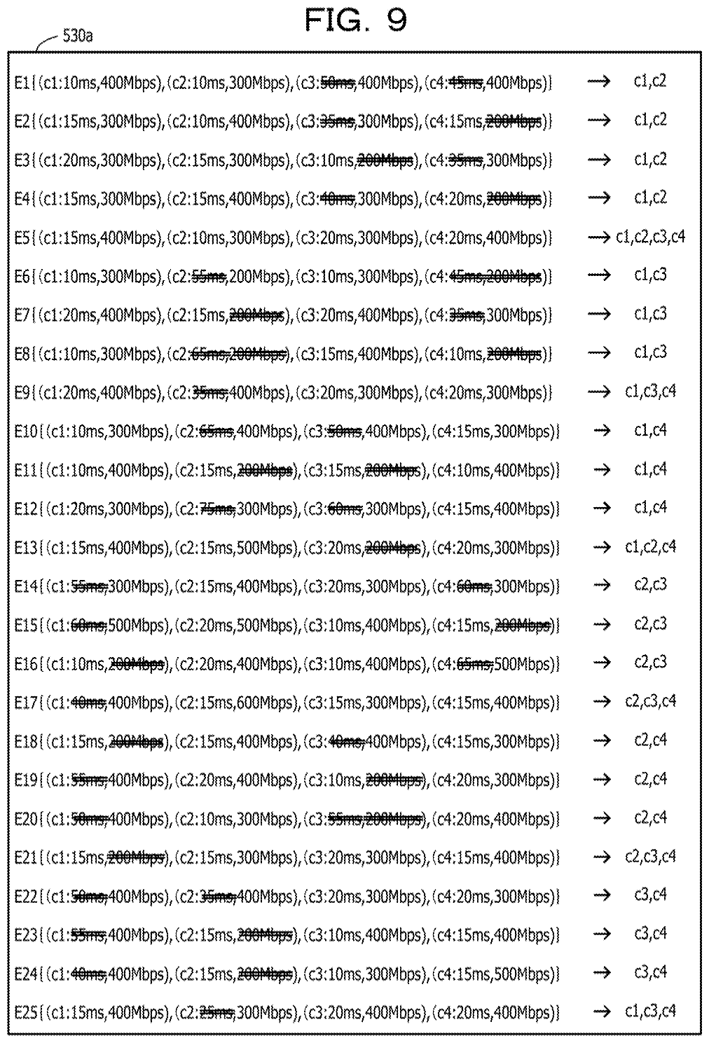

A specific example of selection of possible transmission destinations will be described. FIG. 9 is a diagram illustrating an example of selection of possible transmission destinations of imaging data for an edge device.

Communication performance information 530a in FIG. 9 indicates a state where possible transmission destinations of imaging data for each edge device 200 are selected from the communication performance information 530. For example, the communication performance information 530a indicates a state where possible transmission destinations are selected under the condition that the latency is equal to or less than 20 ms and the bandwidth is equal to or more than 300 Mbps.

For example, the communication performance information 530a indicates that the information processing devices 300-1 and 300-2 for which exchange of imaging data is controlled by c1 and c2, respectively, are selected as the possible transmission destinations of imaging data for E1 to E4. The communication performance information 530a indicates that the information processing devices 300-1, 300-2, 300-3, and 300-4 for which exchange of imaging data is controlled by c1, c2, c3, and c4, respectively, are selected as the possible transmission destinations of imaging data for E5. The communication performance information 530a indicates that the information processing devices 300-1 and 300-3 for which exchange of imaging data is controlled by c1 and c3, respectively, are selected as the possible transmission destinations of imaging data for E6 to E8. The communication performance information 530a indicates that the information processing devices 300-1, 300-3, and 300-4 for which exchange of imaging data is controlled by c1, c3, and c4, respectively, are selected as the possible transmission destinations of imaging data for E9. The communication performance information 530a indicates that the information processing devices 300-1 and 300-4 for which exchange of imaging data is controlled by c1 and c4, respectively, are selected as the possible transmission destinations of imaging data for E10 to E12. The communication performance information 530a indicates that the information processing devices 300-1, 300-2, and 300-4 for which exchange of imaging data is controlled by c1, c2, and c4, respectively, are selected as the possible transmission destinations of imaging data for E13.

The communication performance information 530a indicates that the information processing devices 300-2 and 300-3 for which exchange of imaging data is controlled by c2 and c3, respectively, are selected as the possible transmission destinations of imaging data for E14 to E16. The communication performance information 530a indicates that the information processing devices 300-2, 300-3, and 300-4 for which exchange of imaging data is controlled by c2, c3, and c4, respectively, are selected as the possible transmission destinations of imaging data for E17. The communication performance information 530a indicates that the information processing devices 300-2 and 300-4 for which exchange of imaging data is controlled by c2 and c4, respectively, are selected as the possible transmission destinations of imaging data for E18 to E20. The communication performance information 530a indicates that the information processing devices 300-2, 300-3, and 300-4 for which exchange of imaging data is controlled by c2, c3, and c4, respectively, are selected as the possible transmission destinations of imaging data for E21. The communication performance information 530a indicates that the information processing devices 300-3 and 300-4 for which exchange of imaging data is controlled by c3 and c4, respectively, are selected as the possible transmission destinations of imaging data for E22 to E24. The communication performance information 530a indicates that the information processing devices 300-1, 300-3, and 300-4 for which exchange of imaging data is controlled by c1, c3, and c4, respectively, are selected as the possible transmission destinations of imaging data for E25.

[Step S14] The master controller determines a transmission destination group (two transmission destinations) for each edge device 200 based on the selected possible transmission destinations of imaging data for each edge device 200.

For example, first, the master controller determines transmission destination groups that may be set as transmission destinations for each edge device 200. After that, the master controller sequentially determines transmission destination groups for the edge devices 200 such that the transmission destination groups for the edge devices 200 vary as much as possible.

For example, when possible transmission destinations for each edge device 200 are determined as in the communication performance information 530a, the master controller determines that (c1, c2) is the only transmission destination group that may be set as the transmission destination group for E1 to E4. For example, the master controller determines that the degree of freedom in selecting the transmission destination group for E1 to E4 is 1 (meaning there is one option). The master controller determines that (c1, c2), (c1, c3), (c1, c4), (c2, c3), (c2, c4), and (c3, c4) are the transmission destination groups that may be set as the transmission destination group for E5. For example, the master controller determines that the degree of freedom in selecting the transmission destination group for E5 is 6 (meaning there are six options).

The master controller determines that (c1, c3) is the only transmission destination group that may be set as the transmission destination group for E6 to E8. For example, the master controller determines that the degree of freedom in selecting the transmission destination group for E6 to E8 is 1 (meaning there is one option). The master controller determines that (c1, c3), (c1, c4), and (c3, c4) are the transmission destination groups that may be set as the transmission destination group for E9. For example, the master controller determines that the degree of freedom in selecting the transmission destination group for E9 is 3 (meaning there are three options).

The master controller determines that (c1, c4) is the only transmission destination group that may be set as the transmission destination group for E0 to E12. For example, the master controller determines that the degree of freedom in selecting the transmission destination group for E10 to E12 is 1 (meaning there is one option). The master controller determines that (c1, c2), (c1, c4), and (c2, c4) are the transmission destination groups that may be set as the transmission destination group for E13. For example, the master controller determines that the degree of freedom in selecting the transmission destination group for E13 is 3 (meaning there are three options).

The master controller determines that (c2, c3) is the only transmission destination group that may be set as the transmission destination group for E14 to E16. For example, the master controller determines that the degree of freedom in selecting the transmission destination group for E14 to E16 is 1 (meaning there is one option). The master controller determines that (c2, c3), (c2, c4), and (c3, c4) are the transmission destination groups that may be set as the transmission destination group for E17. For example, the master controller determines that the degree of freedom in selecting the transmission destination group for E17 is 3 (meaning there are three options).

The master controller determines that (c2, c4) is the only transmission destination group that may be set as the transmission destination group for E18 to E20. For example, the master controller determines that the degree of freedom in selecting the transmission destination group for E18 to E20 is 1 (meaning there is one option). The master controller determines that (c2, c3), (c2, c4), and (c3, c4) are the transmission destination groups that may be set as the transmission destination group for E21. For example, the master controller determines that the degree of freedom in selecting the transmission destination group for E21 is 3 (meaning there are three options).

The master controller determines that (c3, c4) is the only transmission destination group that may be set as the transmission destination group for E22 to E24. For example, the master controller determines that the degree of freedom in selecting the transmission destination group for E22 to E24 is 1 (meaning there is one option). The master controller determines that (c1, c3), (c1, c4), and (c3, c4) are the transmission destination groups that may be set as the transmission destination group for E25. For example, the master controller determines that the degree of freedom in selecting the transmission destination group for E25 is 3 (meaning there are three options).

After that, based on the determined transmission destination groups that may be set for each edge device 200, the master controller determines a transmission destination group for each edge device 200 such that the transmission destination groups for the edge devices 200 vary as much as possible.

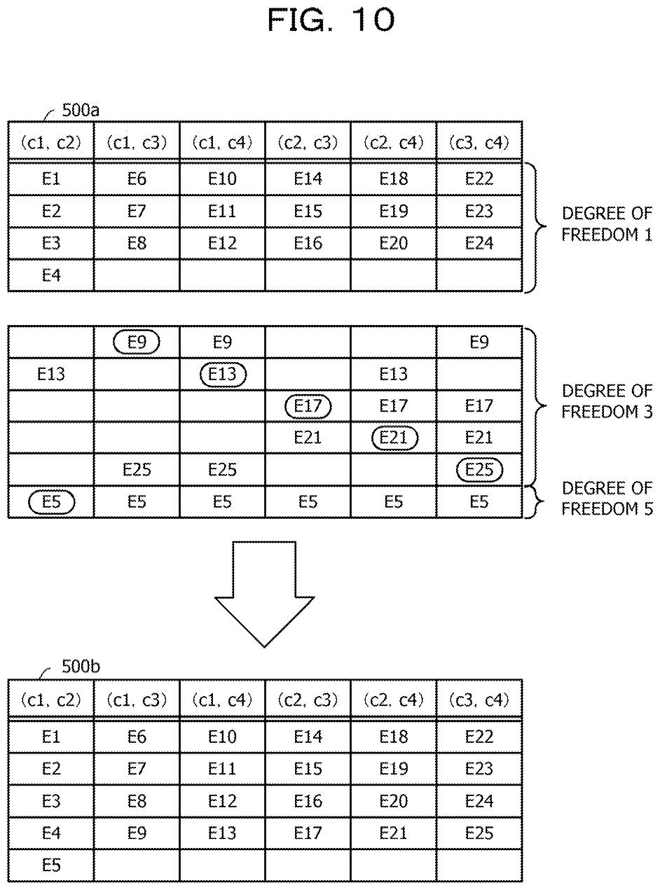

A flow of determining a transmission destination group for each edge device 200 will be described. FIG. 10 is a diagram illustrating an example of determination of a transmission destination group for an edge device.

First, as illustrated in a normal state table 500a, the master controller allocates, to the item of each transmission destination group, the edge devices 200 having the degree of freedom in selecting the transmission destination group of 1 (having only one option).

After that, the master controller allocates, preferentially to the item of the transmission destination group for which the number of set edge devices 200 is small, the edge devices 200 having the degree of freedom in selecting the transmission destination group of 2 or higher, such that the transmission destination groups for the edge devices 200 vary as much as possible. For example, the master controller determines the transmission destination groups to which edge devices are allocated, in order from the edge device 200 having the lowest degree of freedom in selecting the transmission destination group.

For example, the master controller allocates E9 to the item of (c1, c3), E13 to the item of (c1, c4), E17 to the item of (c2, c3), E21 to the item of (c2, c4), E25 to the item of (c3, c4), and E5 to the item of (c1, c2). By such allocation, the master controller creates a normal state table 500b that is in a state where the transmission destination group has been determined for each edge device 200 and the amount of transmitted data is yet to be input.

In this way, the master controller determines a transmission destination group for each edge device 200 such that the transmission destination groups for the edge devices 200 vary as much as possible.

[Step S15] The master controller determines an amount of imaging data transmitted from each edge device 200 to the transmission destination such that the total amount of imaging data received by each information processing device 300 is equal to or less than the bandwidth. The master controller inputs, to the normal state table 500b, the determined amount of transmitted imaging data, and completes the creation of the normal state table 500.

The master controller determines an amount of transmitted imaging data such that the total amount of imaging data received by each information processing device 300 is equal to or less than the bandwidth, and the amounts of imaging data transmitted from each edge device 200 to the transmission destinations are as equal to each other as possible (50:50).

For example, when the amount of imaging data transmitted from each edge device 200 to each transmission destination is 60 Mbps, the master controller first determines whether the total amount of imaging data received by each information processing device 300 is equal to or less than the bandwidth.

When determining that the total amount of imaging data received by each information processing device 300 is equal to or less than the bandwidth, the master controller determines the amount of imaging data transmitted from each edge device 200 to each transmission destination to be 60 Mbps. When determining that the total amount of imaging data received by each information processing device 300 is not equal to or less than the bandwidth, the master controller adjusts the total amount of imaging data transmitted from each edge device 200 to each transmission destination. For example, for the information processing device 300 in which the total amount of received imaging data is not equal to or less than the bandwidth, the master controller makes an adjustment of decreasing the amount of imaging data transmitted from each edge device 200 such that the total amount of received imaging data is equal to or less than the bandwidth.

For example, in a case where the transmission destination group of each edge device 200 is determined as in the normal state table 500b, when the amount of imaging data transmitted from each edge device 200 to each transmission destination is 60 Mbps, the total amount of imaging data received by each information processing device 300 is equal to or less than the bandwidth. Therefore, the master controller determines the amount of imaging data transmitted from each edge device 200 to each transmission destination to be 60 Mbps.

[Step S16] The master controller distributes the normal state table 500 to each edge device 200 and each information processing device 300, and ends the normal state table creation processing.

For example, the master controller distributes the normal state table 500 to each agent 220. Each agent 220 distributes the normal state table 500 to the transmission destination, resulting in that the normal state table 500 is distributed to each edge device 200 and each information processing device 300.

Next, description will be provided for processing of correcting the transmission table 510 when the operating state of the information processing device 300 in the information processing system 100 changes during the operation of the system.

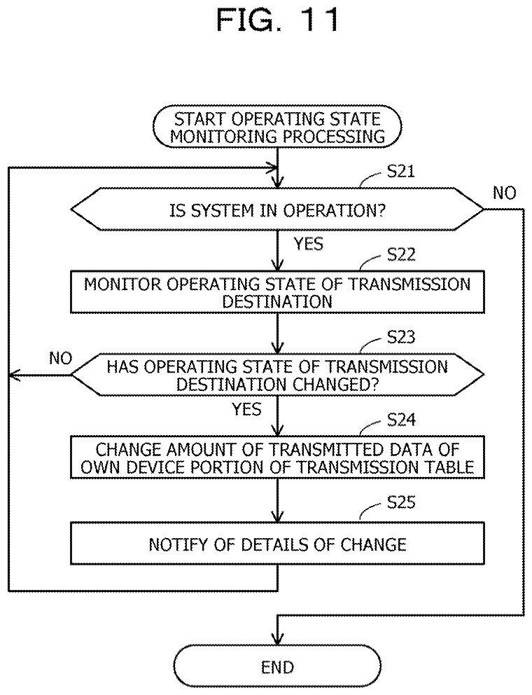

FIG. 11 is a flowchart illustrating an example of operating state monitoring processing. Operating state monitoring processing is processing performed by each agent 220, and is processing continuously performed during system operation. Operating state monitoring processing is processing of detecting a change in the operating state of the information processing device 300 set as a transmission destination of the edge device 200.

[Step S21] The agent 220 determines whether the information processing system 100 is in operation. When determining that the system is in operation, the agent 220 proceeds to step S22. When determining that the system is not in operation, the agent 200 ends the operating state monitoring processing.

[Step S22] The agent 220 monitors the operating state of the transmission destination of imaging data. For example, the agent 220 monitors the operating state of the transmission destination by polling or transmission of imaging data to the transmission destination.

[Step S23] The agent 220 determines whether or not the operating state of the information processing device 300 as the transmission destination has changed. The change in the operating state includes a change from a normally operating state to a failure state and a change from the failure state to the normally operating state.

For example, the agent 220 determines that the operating state has changed when a failure occurs in the information processing device 300 in operation (when there is no response to polling or when an error occurs in transmission of imaging data). The agent 220 determines that the operating state has changed when the information processing device 300 in which a failure has occurred recovers from the failure (when there is a response to polling).

The agent 220 proceeds to step S24 when determining that the operating state of the information processing device 300 as the transmission destination has changed, or proceeds to step S21 when determining that the operating state has not changed.

[Step S24] The agent 220 changes the amount of transmitted data of the own device portion of the transmission table 510.

For example, when the operating state of a transmission destination has changed to the failure state, the agent 220 changes the amount of imaging data transmitted to the transmission destination in the failure state to error, indicating the failure state. The agent 220 changes the amount of imaging data transmitted to the other transmission destination to 120 Mbps. In this way, when the operating state of a transmission destination has changed to the failure state, the agent 220 sets the transmission destination of the imaging data of which the transmission destination is the transmission destination that has changed to the failure state, to the other transmission destination. According to this, since the imaging data of which the transmission destination is the transmission destination whose operating state has changed to the failure state is transmitted to the transmission destination that is processing the imaging data, no application has to be installed and learning data do not have to be taken over. Therefore, the information processing system 100 may suppress a processing delay and continue the processing on the imaging data.

When the operating state of a transmission destination has changed from the failure state to the normally operating state, the agent 220 changes the amount of imaging data transmitted to the transmission destination in the normally operating state to 60 Mbps. The agent 220 changes the amount of imaging data transmitted to the other transmission destination to 60 Mbps.

When the agent 220 changes the amount of transmitted data of the own device portion of the transmission table 510, the information processing system 100 is in a state where the contents of the transmission tables 510 of the edge devices 200 and the information processing devices 300 are temporarily asynchronous.

[Step S25] The agent 220 notifies each controller 330 of the details of change executed in step S24. After notifying of the details of change executed in step S24, the agent 220 proceeds to step S21.

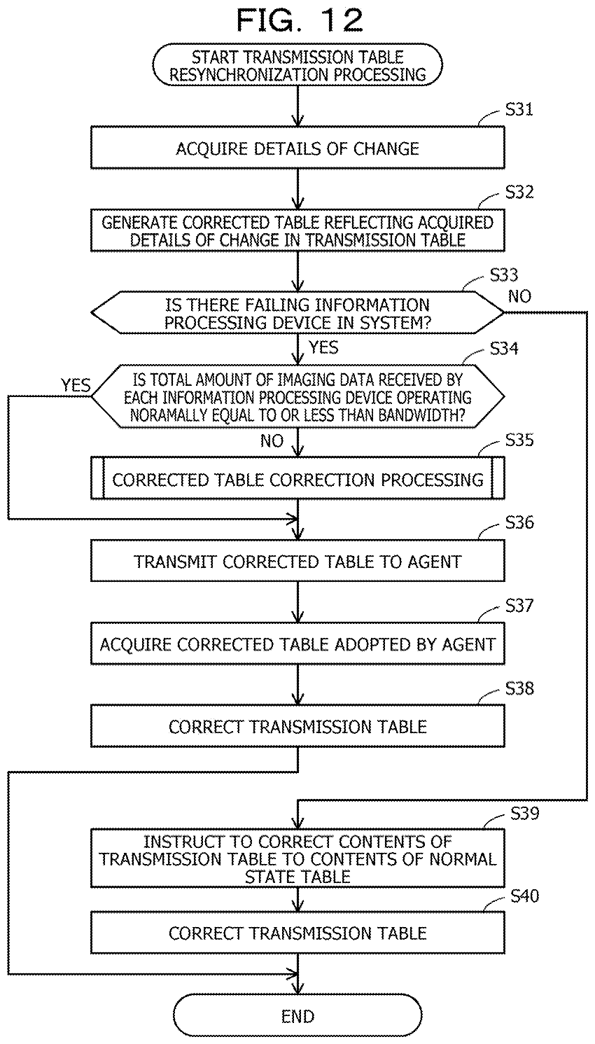

Next, description will be provided for processing of resynchronizing the transmission tables 510 that are asynchronous due to the occurrence of a change in the operating state of the information processing device 300. FIG. 12 is a flowchart illustrating an example of transmission table resynchronization processing.

Transmission table resynchronization processing is processing performed by each controller 330. When receiving the notification from the agent 220 in step S25, the controller 330 performs transmission table resynchronization processing. Transmission table resynchronization processing is processing of resynchronizing the transmission tables 510 of each of the edge devices 200 and each of the information processing devices 300 by causing each controller 330 to correct the transmission table 510 in accordance with a common rule.

[Step S31] By the received notification, the controller 330 acquires the details of change made by the agent 220 to the transmission table 510.

When the operating state of the information processing device 300 has changed, each of the agents 220 for which the information processing device 300 is a transmission destination changes the amount of transmitted imaging data of the own device portion of the transmission table 510. Therefore, the controller 330 acquires the details of change from a plurality of agents 220.

For example, when a failure occurs in the information processing device 300-1 in the state where each information processing device 300 is operating normally, the controller 330 acquires the details of change from the agents 220 of E1 to E13 for which c1 is a transmission destination.

For example, the controller 330 acquires the details of change “E1 (error, 120 Mbps)” from the agent 220 of E1. The controller 330 acquires the details of change “E2 (error, 120 Mbps)” from the agent 220 of E2. The controller 330 acquires the details of change “E3 (error, 120 Mbps)” from the agent 220 of E3. The controller 330 acquires the details of change “E4 (error, 120 Mbps)” from the agent 220 of E4. The controller 330 acquires the details of change “E5 (error, 120 Mbps)” from the agent 220 of E5.

The controller 330 acquires the details of change “E6 (error, 120 Mbps)” from the agent 220 of E6. The controller 330 acquires the details of change “E7 (error, 120 Mbps)” from the agent 220 of E7. The controller 330 acquires the details of change “E8 (error, 120 Mbps)” from the agent 220 of E8. The controller 330 acquires the details of change “E9 (error, 120 Mbps)” from the agent 220 of E9.

The controller 330 acquires the details of change “E10 (error, 120 Mbps)” from the agent 220 of E10. The controller 330 acquires the details of change “E11 (error, 120 Mbps)” from the agent 220 of E11. The controller 330 acquires the details of change “E12 (error, 120 Mbps)” from the agent 220 of E12. The controller 330 acquires the details of change “E13 (error, 120 Mbps)” from the agent 220 of E13.

[Step S32] The controller 330 generates a corrected table reflecting the acquired details of change in the transmission table 510.

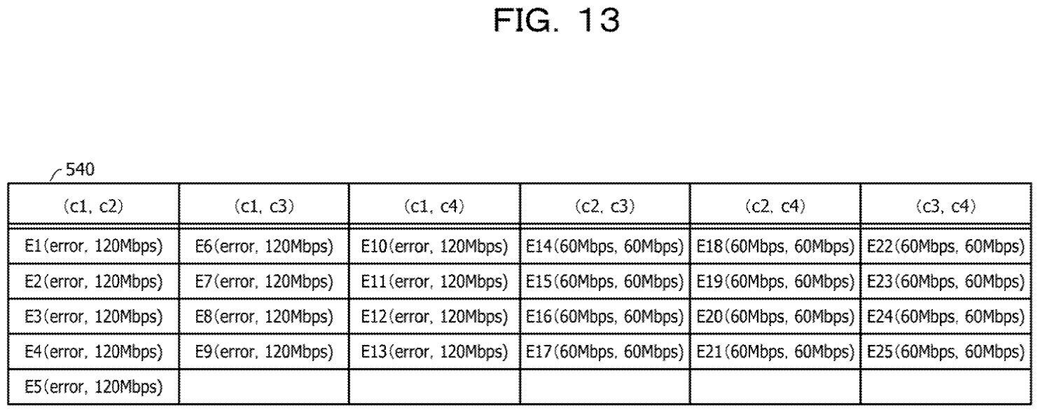

Description will be provided for a corrected table generated when a failure occurs in the information processing device 300-1 in the state where each information processing device 300 is operating normally. FIG. 13 is a diagram illustrating an example of a corrected table.

A corrected table 540 is a table generated when a failure occurs in the information processing device 300-1 in the state where each information processing device 300 is operating normally (a state where the contents of the transmission table 510 are the same as those of the normal state table 500).

The controller 330 generates the corrected table 540 by reflecting, in the transmission table 510, the details of change acquired from the agents 220 of E1 to E13 for which c1 is a transmission destination.

[Step S33] The controller 330 determines whether there is a failure state, for example, a failing information processing device 300, in the information processing system 100. The controller 330 refers to the corrected table, and when there is the edge device 200 of which the amount of data transmitted to a transmission destination is error, determines that there is a failing information processing device 300 in the information processing system 100.

When determining that there is a failing information processing device 300 in the information processing system 100, the controller 330 proceeds to step S34. When determining that there is no failing information processing device 300 in the information processing system 100, the controller 330 proceeds to step S39.

[Step S34] The controller 330 determines whether the total amount of imaging data received by each information processing device 300 operating normally is equal to or less than the bandwidth.

Based on the corrected table, the controller 330 calculates the total amount of imaging data received by each information processing device 300 operating normally. The controller 330 determines whether the calculated total amount of imaging data received by each information processing device 300 operating normally is equal to or less than the bandwidth of each information processing device 300.

When determining that the total amount of imaging data received by each information processing device 300 operating normally is equal to or less than the bandwidth, the controller 330 proceeds to step S36. When determining that there is the information processing device 300 in which the total amount of received imaging data is not equal to or less than the bandwidth among the information processing devices 300 operating normally, the controller 330 proceeds to step S35.

For example, based on the corrected table 540, the controller 330 calculates the total amount of imaging data received by the information processing device 300-2, for which exchange of imaging data is controlled by c2, to be 1080 Mbps. Based on the corrected table 540, the controller 330 calculates the total amount of imaging data received by the information processing device 300-3, for which exchange of imaging data is controlled by c3, to be 960 Mbps. Based on the corrected table 540, the controller 330 calculates the total amount of imaging data received by the information processing device 300-4, for which exchange of imaging data is controlled by c4, to be 960 Mbps. The controller 330 determines that the total amount of imaging data received by the information processing device 300-2, for which exchange of imaging data is controlled by c2, is not equal to or less than the bandwidth.

{Step S35} The controller 330 executes corrected table correction processing. Corrected table correction processing is processing of adjusting the amount of data transmitted from the edge device 200 to the transmission destination, set in a corrected table. In corrected table correction processing, the controller 330 adjusts the amount of imaging data transmitted from the edge device 200 for which a transmission destination is the own information processing device.

For example, the controller 330 makes an adjustment of decreasing the amount of imaging data transmitted to the information processing device 300 in which the total amount of received imaging data is not equal to or less than the bandwidth, and increasing the amount of imaging data transmitted to the information processing device 300 in which the total amount of received imaging data is less than the bandwidth.

The controller 330 not only adjusts the amount of imaging data transmitted from the edge device 200 for which a transmission destination is the own information processing device, but also may adjust the amount of imaging data transmitted from any edge device 200 in the information processing system 100.

[Step S36] The controller 330 transmits the corrected table to each agent 220, and causes the agent to correct the contents of the transmission table 510 to the contents of the corrected table.

Each agent 220 receives corrected tables from a plurality of controllers 330, determines a corrected table to be adopted for correction of the transmission table 510 among the received corrected tables, and corrects the transmission table. Each agent 220 determines a corrected table to be adopted for correction of the transmission table 510 among the received corrected tables in accordance with a predetermined rule. Therefore, each agent 220 corrects the transmission table 510 with the same corrected table. For example, each agent 220 preferentially adopts a corrected table in which the total amount of imaging data received by each information processing device 300 operating normally is equal to or less than the bandwidth.

[Step S37] The controller 330 acquires, from each agent 220, the corrected table adopted by each agent 220 for correction of the transmission table 510.

[Step S38] The controller 330 corrects the contents of the transmission table 510 included in the own information processing device to the contents of the corrected table acquired in step S37. Thus, the contents of the transmission tables 510 of the edge devices 200 and the information processing devices 300 in the information processing system 100 are changed to the contents of the corrected table acquired in step S37 to be in a state where the transmission tables 510 are resynchronized with each other. When the controller 330 finishes correcting the contents of the transmission table 510 included in the own information processing device to the contents of the corrected table acquired in step S37, the controller 330 ends the transmission table resynchronization processing.

[Step S39] The controller 330 instructs each agent 220 to correct the contents of the transmission table 510 to the contents of the normal state table 500. At this time, the controller 330 may issue the instruction in step S39 only to the agent that transmits data to the own information processing device.

[Step S40] The controller 330 corrects the contents of the transmission table 510 included in the own information processing device to the contents of the normal state table 500. Thus, the contents of the transmission tables 510 of the edge devices 200 and the information processing devices 300 in the information processing system 100 are changed to the contents of the normal state table 500 to be in a state where the transmission tables 510 are resynchronized with each other. When the controller 330 finishes correcting the contents of the transmission table 510 included in the own information processing device to the contents of the normal state table 500, the controller 330 ends the transmission table resynchronization processing.

In step S24, the notification of the details of change by the agent 220 in step S25 in a case where the operating state of a certain transmission destination has changed to the failure state may be made only to the information processing device that is the normally-operating data transmission destination for the agent 220. In this case, the information processing device may generate a corrected table through communication between each agent 220 and the information processing device. Each agent 220 provides the contents of the corrected table finally received from the information processing device to the other information processing device that is a data transmission destination for the agent 220, thereby resynchronizing the transmission tables of the agents 220 and the information processing devices 300.

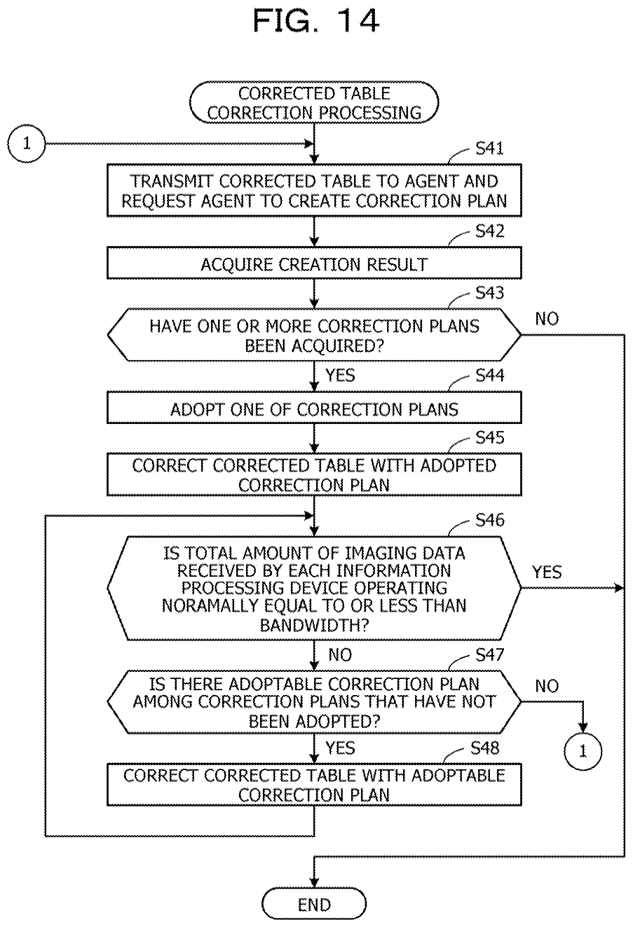

Next, corrected table correction processing will be described. FIG. 14 is a flowchart illustrating an example of corrected table correction processing.

Corrected table correction processing is processing of adjusting the amount of imaging data transmitted from the edge device 200 to the transmission destination set in a corrected table. Corrected table correction processing is executed by the controller 330.

[Step S41] The controller 330 transmits a corrected table to the agent 220 including the own information processing device as a transmission destination, and requests the agent 220 to create a correction plan for the amount of transmitted imaging data of the own device portion.

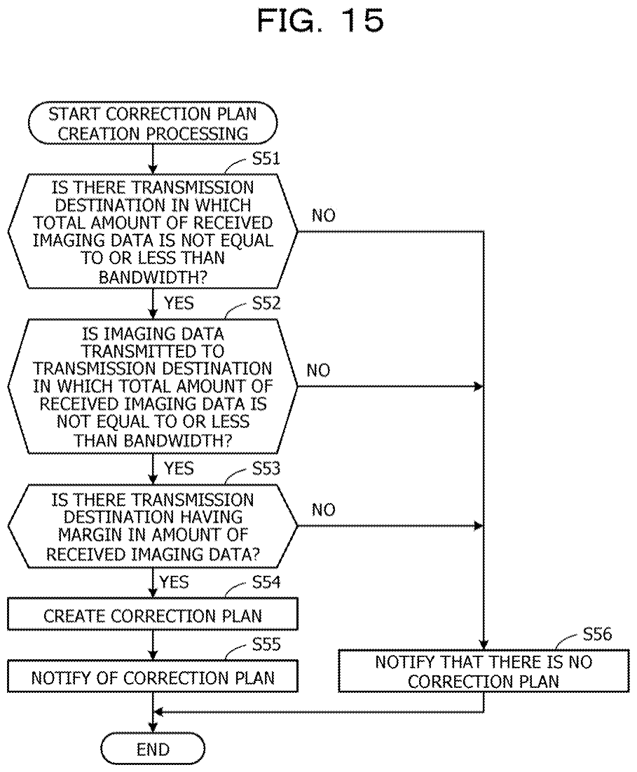

The agent 220 having received the request creates a correction plan through correction plan creation processing described later when the amount of transmitted imaging data of the own device portion may be corrected. When the amount of transmitted imaging data of the own device portion may not be corrected the agent 220 notifies that there is no correction plan. For example, when the total amount of received imaging data of one of the transmission destinations is not within the bandwidth and the total amount of received imaging data of the other is less than the bandwidth, the agent 220 creates a correction plan of decreasing the amount of transmission to the one and increasing the amount of transmission to the other. Correction plan creation processing will be described later in more detail with reference to FIG. 15.

[Step S42] The controller 330 acquires a creation result from the agent 220 having been requested to create a correction plan.

[Step S43] The controller 330 determines whether or not one or more correction plans have been acquired. When determining that one or more correction plans have been acquired, the controller 330 proceeds to step S44. When determining that correction plan has not been acquired (or when there is no room for correction), the controller 330 ends the corrected table correction processing.

[Step S44] The controller 330 determines a correction plan to be adopted first from the acquired correction plans, and adopts the correction plan.

For example, the controller 330 determines the priority order for each of the acquired correction plans in accordance with a predetermined rule, and determines the correction plan with the highest priority order as the correction plan to be adopted first. Examples of the predetermined rule for determining the priority order include a method of determining the priority order in accordance with the row number (record number) and the column number of the position (field) in the corrected table to be corrected with the correction plan, and other methods. For example, the controller 330 makes the priority order of a correction plan higher as the row number of a field to be corrected is smaller, and for correction plans with the same row number of a field to be corrected, makes the priority order of a correction plan higher as the column number of a field to be corrected is smaller. In the following description, the priority order is determined by a method in which the priority order of a correction plan is made higher as the row number of a field to be corrected is smaller, and for correction plans with the same row number of a field to be corrected, the priority order of a correction plan is made higher as the column number of a field to be corrected is smaller.

[Step S45] The controller 330 corrects the corrected table with the adopted correction plan.

[Step S46] The controller 330 determines whether the total amount of imaging data received by each information processing device 300 operating normally is equal to or less than the bandwidth when imaging data is transmitted in accordance with the corrected table which is corrected.

In a case of determining that the total amount of imaging data received by each information processing device 300 operating normally is equal to or less than the bandwidth when imaging data is transmitted in accordance with the corrected table which is corrected, the controller 330 ends the corrected table correction processing. In a case of determining that there is the information processing device 300 in which the total amount of received imaging data is not equal to or less than the bandwidth among the information processing devices 300 operating normally when imaging data is transmitted in accordance with the corrected table which is corrected, the controller 330 proceeds to step S47.

[Step S47] The controller 330 determines whether there is an adoptable correction plan among the correction plans that have not been adopted.

The controller 330 determines, as an adoptable correction plan, a correction plan that decreases the amount of imaging data transmitted to the information processing device 300 in which the total amount of received imaging data is not equal to or less than the bandwidth, and that does not newly generate any information processing device 300 in which the total amount of received imaging data is not equal to or less than the bandwidth.

When determining that there is an adoptable correction plan among the correction plans that have not been adopted, the controller 330 proceeds to step S48. When determining that there is no adoptable correction plan among the correction plans that have not been adopted, the controller 330 proceeds to step S41.

[Step S48] The controller 330 corrects the corrected table with the adoptable correction plan, and proceeds to step S46. For example, the controller 330 corrects the corrected table with the correction plan with the highest priority order among adoptable correction plans.

Next, correction plan creation processing will be described. FIG. 15 is a flowchart illustrating an example of correction plan creation processing. Correction plan creation processing is processing performed by the agent 220 in response to a request from the controller 330 to create a correction plan. In correction plan creation processing, based on the corrected table received from the controller 330, the agent 220 creates a correction plan for adjusting the amount of transmitted imaging data of the own device portion in the corrected table.

[Step S51] The agent 220 determines whether or not there is a transmission destination in which, when transmitting imaging data in accordance with the corrected table, the total amount of received imaging data is not equal to or less than the bandwidth, in the transmission destinations to which the own device transmits imaging data.

When determining that there is a transmission destination in which, when transmitting imaging data in accordance with the corrected table, the total amount of received imaging data is not equal to or less than the bandwidth, in the transmission destinations to which the own device transmits imaging data, the agent 220 proceeds to step S52. When determining that there is no transmission destination in which, when transmitting imaging data in accordance with the corrected table, the total amount of received imaging data is not equal to or less than the bandwidth, in the transmission destinations to which the own device transmits imaging data, the agent 220 proceeds to step S56.

[Step S52] The agent 220 determines whether or not imaging data is transmitted to a transmission destination in which the total amount of received imaging data is not equal to or less than the bandwidth when transmitting imaging data in accordance with the corrected table.

When determining that imaging data is transmitted to a transmission destination in which the total amount of received imaging data is not equal to or less than the bandwidth when transmitting imaging data in accordance with the corrected table, the agent 220 proceeds to step S53. When determining that imaging data is not transmitted to a transmission destination in which the total amount of received imaging data is not equal to or less than the bandwidth when transmitting imaging data in accordance with the corrected table, the agent 220 proceeds to step S56.

[Step S53] The agent 220 determines whether or not there is a transmission destination having a margin in the total amount of received imaging data in the transmission destinations to which the own device transmits imaging data, when transmitting imaging data in accordance with the corrected table.

The agent 220 determines that there is a transmission destination having a margin in the total amount of received imaging data when there is a transmission destination in which the total amount of received imaging data is less than the bandwidth in the transmission destinations to which the own device transmits imaging data.

In a case of determining that there is a transmission destination having a margin in the total amount of received imaging data in the transmission destinations to which the own device transmits imaging data when transmitting imaging data in accordance with the corrected table, the agent 220 proceeds to step S54. In a case of determining that there is no transmission destination having a margin in the total amount of received imaging data in the transmission destinations to which the own device transmits imaging data when transmitting imaging data in accordance with the corrected table, the agent 220 proceeds to step S56.

[Step S54] The agent 220 creates a correction plan for the amount of transmitted imaging data of the own device portion of the corrected table.

The agent 220 creates a correction plan of increasing the amount of transmission to a transmission destination having a margin in the total amount of received imaging data within a range in which the total amount of received imaging data does not exceed the bandwidth, and decreasing, by the amount of increase, the amount of transmission to a transmission destination in which the total amount of received imaging data is not equal to or less than the bandwidth, in accordance with a predetermined rule.

[Step S55] The agent 220 notifies the controller 330 that has requested to create a correction plan of the created correction plan, and ends the correction plan creation processing.

[Step S56] The agent 220 notifies the controller 330 that has requested to create a correction plan that there is no correction plan (that there is no room for correction), and ends the correction plan creation processing.

For example, when a corrected table received from the controller 330 is the corrected table 540, the agents 220 of E1 to E5 transmit imaging data to the information processing device 300-2 in which the total amount of received imaging data is not equal to or less than the bandwidth and for which exchange of data is controlled by c2. Therefore, the agents 220 of E1 to E5 determine YES in step S51 and step S52. However, since the information processing device 300-1 as the other transmission destination for which exchange of data is controlled by c1, is in failure, for example, is not in a state of having a margin in the total amount of received imaging data, the agents 220 of E1 to E5 determine NO in step S53. Therefore, the agents 220 of E1 to E5 notify that there is no correction plan when receiving a request to create a correction plan.

When a corrected table received from the controller 330 is the corrected table 540, the agents 220 of E6 to E9 determine NO in step S51 since imaging data is not transmitted to the transmission destination in which the total amount of received imaging data is not equal to or less than the bandwidth. Therefore, the agents 220 of E6 to E9 notify that there is no correction plan when receiving a request to create a correction plan.

When a corrected table received from the controller 330 is the corrected table 540, the agents 220 of E10 to E13 determine NO in step S51 since imaging data is not transmitted to the transmission destination in which the total amount of received imaging data is not equal to or less than the bandwidth. Therefore, the agents 220 of E10 to E13 notify that there is no correction plan when receiving a request to create a correction plan.

When a corrected table received from the controller 330 is the corrected table 540, the agents 220 of E14 to E17 transmit imaging data to the information processing device 300-2 in which the total amount of received imaging data is not equal to or less than the bandwidth and for which exchange of data is controlled by c2. Therefore, the agents 220 of E14 to E17 determine YES in step S51 and step S52. In the information processing device 300-3 as the other transmission destination for which exchange of data is controlled by c3, the total amount of received imaging data is 960 Mbps (less than 1000) and there is a margin of 40 Mbps in the total amount of received data. Therefore, the agents 220 of E14 to E17 determine YES in step S53. For example, the agents 220 of E14 to E17 create a correction plan and notify of the correction plan when receiving a request to create a correction plan. For example, the agents 220 of E14 to E17 notify of a correction plan of setting the amount of transmission to the information processing device 300-3 to 100 Mbps, increased by the upper limit value that may be increased, and setting the amount of transmission to the information processing device 300-2 to 20 Mbps, decreased by the amount of increase.

When a corrected table received from the controller 330 is the corrected table 540, the agents 220 of E18 to E21 transmit imaging data to the information processing device 300-2 in which the total amount of received imaging data is not equal to or less than the bandwidth and for which exchange of data is controlled by c2. Therefore, the agents 220 of E18 to E21 determine YES in step S51 and step S52. In the information processing device 300-4 as the other transmission destination for which exchange of data is controlled by c4, the total amount of received imaging data is 960 Mbps (less than 1000) and there is a margin of 40 Mbps in the total amount of received data. Therefore, the agents 220 of E18 to E21 determine YES in step S53. For example, the agents 220 of E18 to E21 create a correction plan and notify of the correction plan when receiving a request to create a correction plan. For example, the agents 220 of E18 to E21 notify of a correction plan of setting the amount of transmission to the information processing device 300-4 to 100 Mbps, increased by the upper limit value that may be increased, and setting the amount of transmission to the information processing device 300-2 to 20 Mbps, decreased by the amount of increase.

When a corrected table received from the controller 330 is the corrected table 540, the agents 220 of E22 to E25 determine NO in step S51 since imaging data is not transmitted to the transmission destination in which the total amount of received imaging data is not equal to or less than the bandwidth. Therefore, the agents 220 of E22 to E25 notify that there is no correction plan when receiving a request to create a correction plan.

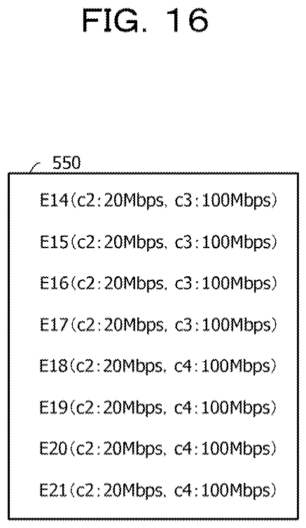

Description will be provided for a specific example of a creation result of a correction plan acquired by the controller 330 in step S42 in the corrected table correction processing of FIG. 14. FIG. 16 is a diagram illustrating an example of correction plan information.

Correction plan information 550 is listed information on correction plans acquired from E1 to E5 and E14 to E21 when c2 transmits the corrected table 540 to E1 to E5 and E14 to E21 including the information processing device 300-2 as a transmission destination and requests E1 to E5 and E14 to E21 to create a correction plan.

The correction plan information 550 includes correction plans of the amount of transmitted imaging data for E14 to E21. For example, the correction plan information 550 indicates that there is no room for correction of the amount of transmitted imaging data for E1 to E5.

For example, the correction plan information 550 includes the correction plan for E14 (c2: 20 Mbps, c3: 100 Mbps). The correction plan for E14 (c2: 20 Mbps, c3: 100 Mbps) indicates a plan of setting the amount of imaging data transmitted from E14 to the information processing device 300-2, for which exchange of imaging data is controlled by c2, to 20 Mbps. The correction plan for E14 (c2: 20 Mbps, c3: 100 Mbps) indicates a plan of setting the amount of imaging data transmitted from E14 to the information processing device 300-3, for which exchange of imaging data is controlled by c3, to 100 Mbps.

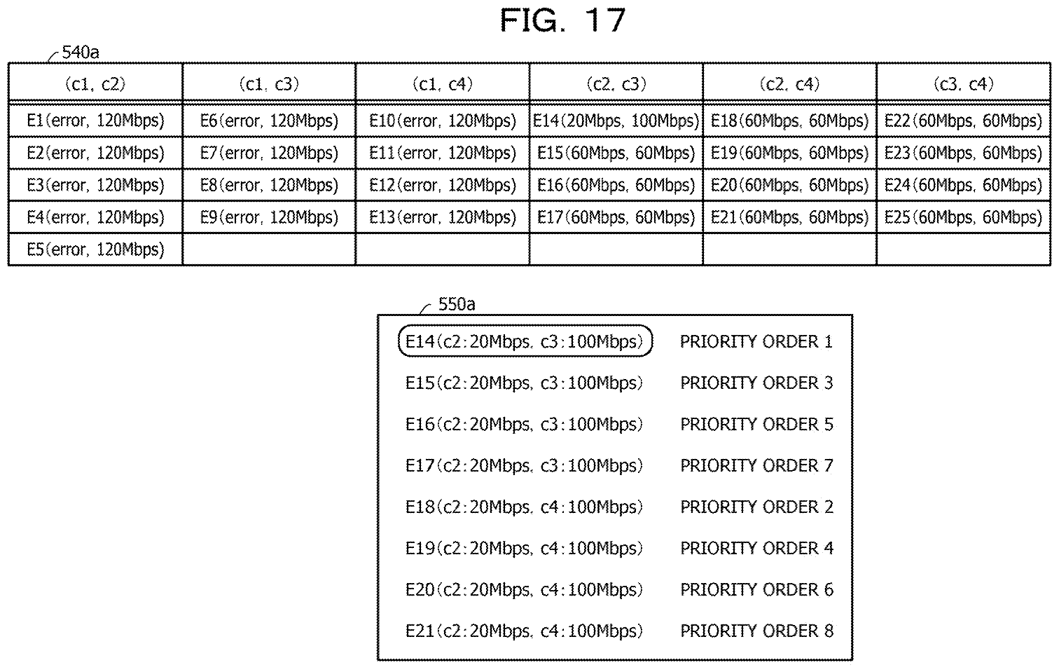

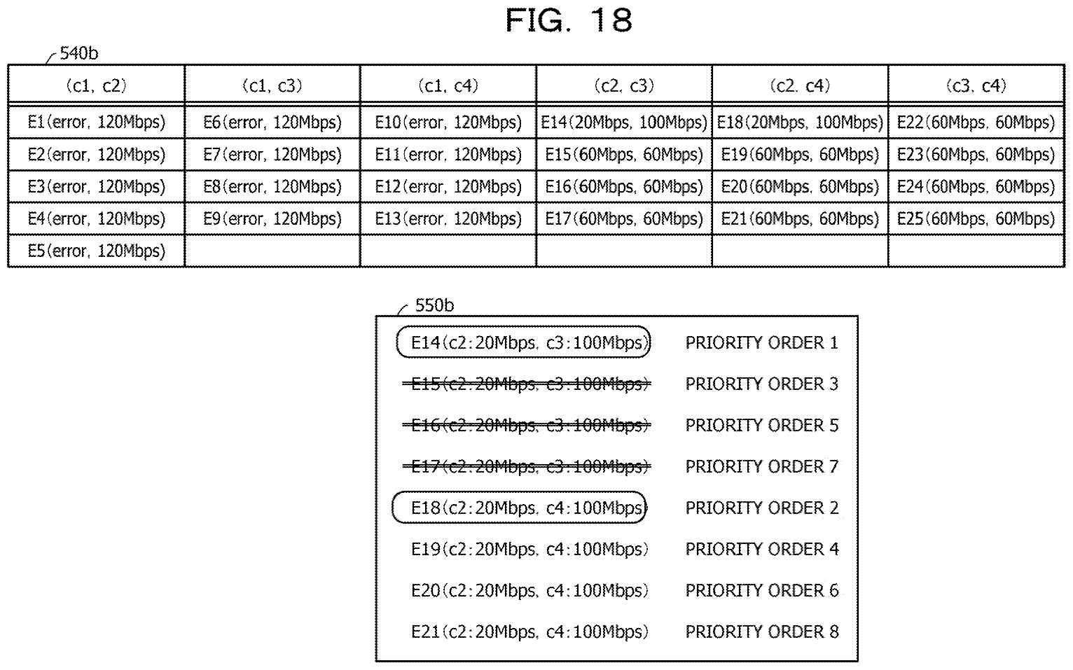

Next, correction of a corrected table based on a correction plan will be described by using a specific example of correcting the corrected table 540 by the correction plan information 550. FIG. 17 is a diagram (part 1) for describing correction of a corrected table. FIG. 18 is a diagram (part 2) for describing correction of a corrected table.

First, c2 determines the priority order in accordance with a rule in which the priority order of a correction plan is made higher as the row number of a field to be corrected is smaller, and for correction plans with the same row number of a field to be corrected, the priority order of a correction plan is made higher as the column number of a field to be corrected is smaller.

For example, as indicated in correction plan information 550a, the priority order is determined to be the order of the correction plan for E14, the correction plan for E18, the correction plan for E15, the correction plan for E19, the correction plan for E16, the correction plan for E20, the correction plan for E17, and the correction plan for E21.

As indicated in the correction plan information 550a, c2 adopts the correction plan for E14 whose priority order is 1 (step S44), and corrects the corrected table 540 to a corrected table 540a (step S45).

When imaging data is transmitted in accordance with the corrected table 540a, the total amount of imaging data received by the information processing device 300-2 is 1040 Mbps. The total amount of imaging data received by the information processing device 300-3 is 1000 Mbps. The total amount of imaging data received by the information processing device 300-4 is 960 Mbps.

Therefore, c2 determines that there is the information processing device 300 in which the total amount of received imaging data is not equal to or less than the bandwidth (step S46: NO), and determines whether or not there is an adoptable correction plan among the correction plans that have not been adopted (step S47).

Since the total amount of imaging data received by the information processing device 300-3 is 1000 Mbps, when the correction plans for E15 to E17 are adopted, the information processing device 300 in which the total amount of received imaging data is not equal to or less than the bandwidth is newly generated. Therefore, c2 determines the correction plans for E15 to E17 as correction plans that may not be adopted.

On the other hand, the total amount of imaging data received by the information processing device 300-4 remains 960 Mbps. Therefore, when the correction plans for E18 to E21 are adopted, the amount of imaging data transmitted to the information processing device 300-2 may be decreased, and no information processing device 300 in which the total amount of received imaging data is not equal to or less than the bandwidth is newly generated. Therefore, c2 determines the correction plans for E18 to E21 as correction plans that may be adopted.

As indicated in correction plan information 550b, c2 adopts the correction plan for E18 whose priority order is the highest among E18 to E21, and corrects the corrected table 540a to a corrected table 540b (step S48).

When imaging data is transmitted in accordance with the corrected table 540b, the total amount of imaging data received by the information processing device 300-2 is 1000 Mbps. The total amount of imaging data received by the information processing device 300-3 is 1000 Mbps. The total amount of imaging data received by the information processing device 300-4 is 1000 Mbps.

Therefore, c2 determines that the total amount of imaging data received by each information processing device 300 operating normally is equal to or less than the bandwidth of each information processing device 300 (step S46: YES), and ends the corrected table correction processing.

Similarly, c3 and c4 may correct the corrected table through corrected table correction processing.

When c3 performs corrected table correction processing when a failure occurs in the information processing device 300-1 in the state where each information processing device 300 is operating normally, c3 acquires only the correction plans for E14 to E17.

Therefore, in the corrected table corrected by c3 through corrected table correction processing, the total amount of imaging data received by the information processing device 300-2 is 1040 Mbps. The total amount of imaging data received by the information processing device 300-3 is 1000 Mbps. The total amount of imaging data received by the information processing device 300-4 is 960 Mbps.

When c4 performs corrected table correction processing when a failure occurs in the information processing device 300-1 in the state where each information processing device 300 is operating normally, c4 acquires only the correction plans for E18 to E21.

Therefore, in the corrected table corrected by c4 through corrected table correction processing, the total amount of imaging data received by the information processing device 300-2 is 1040 Mbps. The total amount of imaging data received by the information processing device 300-3 is 960 Mbps. The total amount of imaging data received by the information processing device 300-4 is 1000 Mbps.

Therefore, when a failure occurs in the information processing device 300-1 in the state where each information processing device 300 is operating normally, each agent 220 adopts the corrected table corrected by c2.

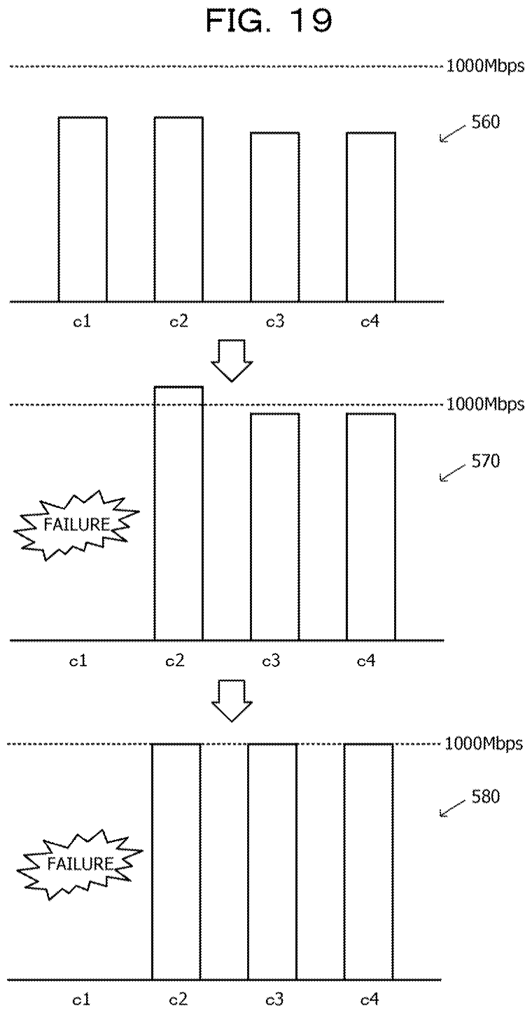

Next, description will be provided for transition of the total amount of imaging data received by each information processing device 300 in a case where a failure occurs in the information processing device 300-1 in the state where each information processing device 300 is operating normally. FIG. 19 is a diagram for describing transition of the total amount of imaging data received by each information processing device.

A state 560 indicates the total amount of imaging data received by each information processing device 300 in the state where each information processing device 300 is operating normally. For example, the state 560 indicates the total amount of imaging data received by each information processing device 300 in a case where imaging data is transmitted in accordance with the transmission table 510 whose contents are those of the normal state table 500.

In the state 560, the total amount of imaging data received by the information processing device 300-1, for which exchange of imaging data is controlled by c1, is 780 Mbps. The total amount of imaging data received by the information processing device 300-2, for which exchange of imaging data is controlled by c2, is 780 Mbps. The total amount of imaging data received by the information processing device 300-3, for which exchange of imaging data is controlled by c3, is 720 Mbps. The total amount of imaging data received by the information processing device 300-4, for which exchange of imaging data is controlled by c4, is 720 Mbps. Therefore, in the state 560, the total amount of imaging data received by each information processing device 300 is equal to or less than the bandwidth of each information processing device 300.

A state 570 indicates the total amount of imaging data received by each information processing device 300 in a state where a failure occurs in the information processing device 300-1 in the state 560, and the agent 220 for which the information processing device 300-1 is a transmission destination changes the amount of transmitted data in step S24. For example, the state 570 indicates the total amount of imaging data received by each information processing device 300 in a state where the transmission tables 510 of the edge devices 200 and the information processing devices 300 are asynchronous. For example, the state 570 indicates the total amount of imaging data received by each information processing device 300 in a case where imaging data is transmitted based on the contents of the corrected table 540.

In the state 570, the total amount of imaging data received by the information processing device 300-2, for which exchange of imaging data is controlled by c2, is 1080 Mbps. The total amount of imaging data received by the information processing device 300-3, for which exchange of imaging data is controlled by c3, is 960 Mbps. The total amount of imaging data received by the information processing device 300-4, for which exchange of imaging data is controlled by c4, is 960 Mbps. Therefore, in the state 570, the total amount of imaging data received by the information processing device 300-2 is not equal to or less than the bandwidth.

A state 580 indicates the total amount of imaging data received by each information processing device 300 in a state where transmission table resynchronization processing performed in the state 570 has ended and the transmission tables 510 of the edge devices 200 and the information processing devices 300 are synchronized with each other. For example, the state 580 indicates the total amount of imaging data received by each information processing device 300 in a case where imaging data is transmitted based on the transmission table 510 that has been corrected to the contents of the corrected table 540b.

In the state 580, the total amount of imaging data received by the information processing device 300-2, for which exchange of imaging data is controlled by c2, is 1000 Mbps. The total amount of imaging data received by the information processing device 300-3, for which exchange of imaging data is controlled by c3, is 1000 Mbps. The total amount of imaging data received by the information processing device 300-4, for which exchange of imaging data is controlled by c4, is 1000 Mbps. Therefore, in the state 580, the total amount of imaging data received by each information processing device 300 operating normally is equal to or less than the bandwidth of each information processing device 300.

As described above, in the information processing system 100, when the information processing device 300 is in failure, imaging data of which transmission destination is the information processing device 300 is transmitted to the information processing device 300 as the other transmission destination instead of the information processing device 300, and the processing is continued.

When the total amount of imaging data received by the other information processing devices 300 exceeds the bandwidth as a result of the continuation of the processing, the information processing system 100 adjusts the amount of transmission from the edge device 200 to each information processing device 300, thereby reducing the increase in the total amount.

For example, the information processing system 100 adjusts the amount of transmission to each transmission destination from the edge device 200 for which the information processing device 300 in the failure state is not the transmission destination, thereby reducing the total amount of imaging data received by the information processing device 300 that continues the processing for the information processing device 300 in the failure state.

Accordingly, the information processing system 100 may suppress a situation where the total amount of imaging data received by the information processing device 300 that continues the processing of the information processing device 300 in which a failure has occurred becomes excessive and the real-time performance of the function provided to a user is impaired.

As described above, according to the information processing system 100, it is possible to suppress concentration of the load on the other information processing device due to a failure of any information processing device. As a result, a highly fault-tolerant system with improved availability may be realized while suppressing a processing delay in the information processing system 100.

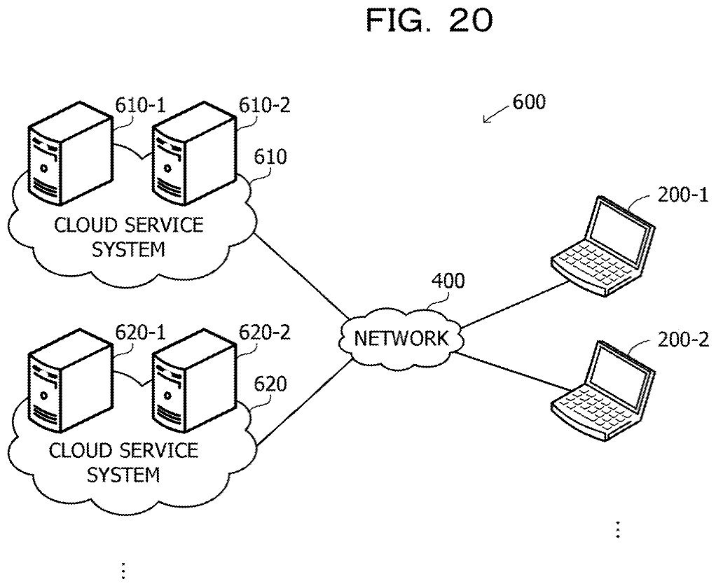

Next, a modification example of the information processing system 100 will be described. FIG. 20 is a diagram describing a modification example of the information processing system according to the second embodiment.

An information processing system 600 is a modification example of the information processing system 100. The information processing system 600 is a multi-cloud system including a plurality of edge devices and a plurality of cloud service systems. The plurality of edge devices and the plurality of cloud service systems are coupled so as to communicate with each other via the network 400. For example, the plurality of edge devices include the edge devices 200-1, 200-2, . . . . The plurality of cloud service systems include cloud service systems 610, 620, . . . . The cloud service system 610 is realized by a plurality of servers 610-1, 610-2, . . . . The cloud service system 620 is realized by a plurality of servers 620-1, 620-2, . . . .

The information processing system 600 is a system in which two or more cloud service systems among the cloud service systems 610, 620, . . . process, in a distributed manner, pieces of imaging data respectively acquired by the edge devices 200-1, 200-2, . . . .

As described above, the information processing system 600 may be a multi-cloud system including a plurality of cloud service systems instead of the plurality of information processing devices 300. In this case, by the cloud service system realizing the functions of the information processing device 300 described above, the information processing system 600 may realize the same processing as that of the information processing system 100.

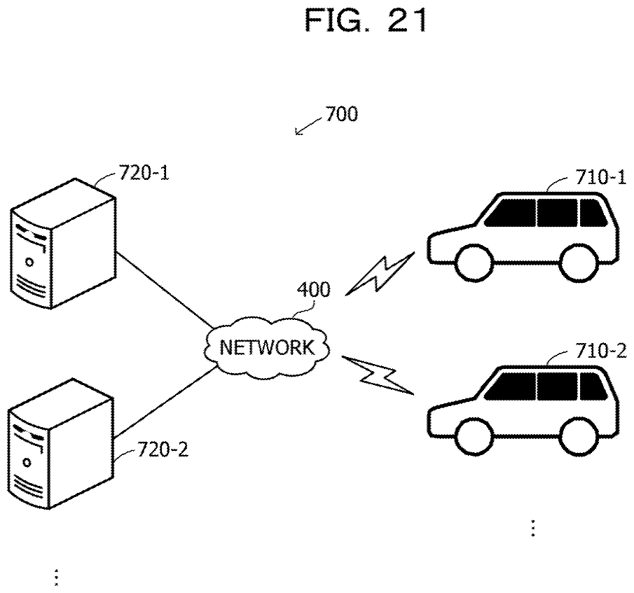

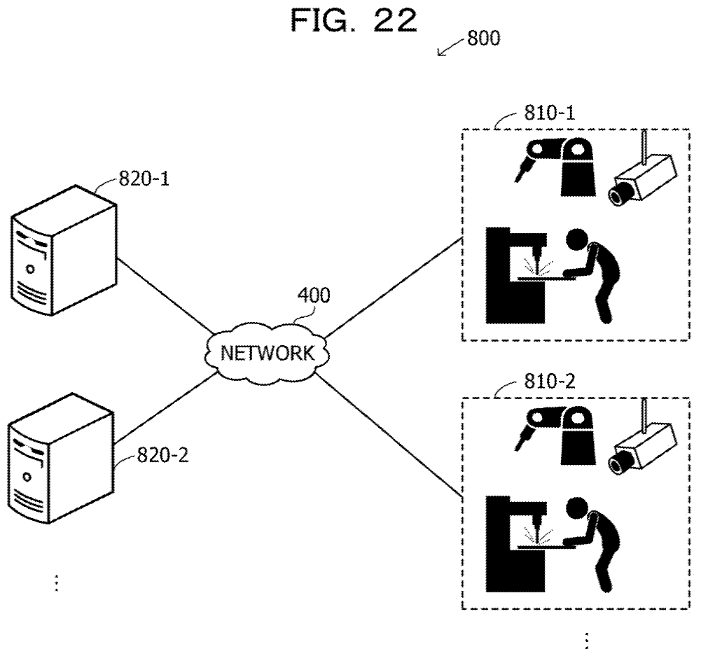

Next, specific examples of application of the information processing system 100 will be described. FIG. 21 is a diagram (part 1) illustrating a specific example of application of the information processing system. FIG. 22 is a diagram (part 2) illustrating a specific example of application of the information processing system.

First, FIG. 21 is described. FIG. 21 is a diagram illustrating an overview of an automatic driving system 700.

The automatic driving system 700 includes a plurality of automobiles and a plurality of information processing devices. For example, the plurality of automobiles include automobiles 710-1, 710-2, . . . . The plurality of information processing devices include information processing devices 720-1, 720-2, . . . .

The automatic driving system 700 is a system in which imaging data obtained by an automobile is analyzed by two or more information processing devices in a distributed manner, an occurrence of an accident is detected based on an analysis result, and automatic stop of surrounding automatic-driving automobiles is executed based on a detection result.

The technique of reducing the load when a failure occurs, which has been described by using the information processing system 100, is applicable to such automatic driving system 700 in which imaging data obtained by an automobile is processed by two or more information processing devices in a distributed manner.

In this case, the system may be realized by the information processing devices 720-1, 720-2, . . . executing the processing executed by the information processing device 300, and by a computer built in the automobiles 710-1, 710-2, . . . executing the processing executed by the edge device 200 described above.

Next, FIG. 22 is described. FIG. 22 is a diagram illustrating an overview of a factory system 800.

The factory system 800 includes a plurality of factories and a plurality of information processing devices. For example, the plurality of factories include factories 810-1, 810-2, . . . . The plurality of information processing devices include information processing devices 820-1, 820-2, . . . .

The factory system 800 is a system in which imaging data obtained by imaging the inside of a factory is analyzed by two or more information processing devices in a distributed manner, an abnormality of the factory is detected based on an analysis result, and warning to employees in the factory and emergency stop of devices in operation in the factory are executed based on a detection result.

The technique of reducing the load when a failure occurs, which has been described by using the information processing system 100, is applicable to such factory system 800 in which imaging data obtained by imaging the inside of a factory is processed by two or more information processing devices in a distributed manner.

In this case, the system may be realized by the information processing devices 820-1, 820-2, . . . executing the processing executed by the information processing device 300, and by a computer in the factories 810-1, 810-2, . . . executing the processing executed by the edge device 200 described above.

Information processing by the edge devices 10, 11, . . . according to the first embodiment may be achieved by causing the CPU of the edge devices 10 11, . . . to execute a program. Information processing by the information processing devices 20, 21, 22, . . . according to the first embodiment may be achieved by causing the CPU of the information processing devices 20, 21, 22, . . . to execute a program. Information processing of the edge device 200 according to the second embodiment may be achieved by causing the CPU 201 to execute a program. Information processing of the information processing device 300 according to the second embodiment may be achieved by causing the CPU of the information processing device to execute a program.

Programs may be recorded in a computer-readable recording medium. For example, programs may be circulated by distributing a recording medium in which the programs are recorded. Programs may be stored in another computer and distributed through a network. For example, a computer may store (install), in a storage device such as a RAM, programs recorded in a recording medium or programs received from another computer, and read the programs from the storage device to execute the programs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a plurality of edge devices; and
a plurality of information processing devices, wherein
two or more information processing devices included in the plurality of information processing devices perform processing data acquired by each of the plurality of edge devices in a distributed manner,
the plurality of edge devices includes:
a first edge device configure to transmit first data to a first information processing device included in the plurality of information processing device, transmit second data to a second information processing device included in the plurality of information processing device, and when detecting a failure of the first information processing device, transmit the first data to the second information processing device instead of the first information processing device, and
a second edge device configured to transmit a first amount of data to the second information processing device, transmit a second amount of data to a third information processing device included in the plurality of information processing device, and when detecting that a total amount of the data transmitted to the second information processing device increases due to the failure, decrease the first amount and increase the second amount.

2. The information processing system according to claim 1, wherein
the first edge device notifies, when transmitting the first data to the second information processing device instead of the first information processing device, the second information processing device of information indicating an amount of the first data and an amount of the second data transmitted to the second information processing device, and
the second edge device receives, from the second information processing device, information indicating a total amount of the data received by the second information processing device from two or more edge devices included in the plurality of edge devices.

3. The information processing system according to claim 1, wherein
the second edge device decreases the first amount and increases the second amount when a total amount of the data received by the second information processing device is larger than a first threshold and a total amount of the data received by the third information processing device is smaller than a second threshold.

4. The information processing system according to claim 3, wherein
the plurality of the edge devices further includes
a third edge device configured to transmit a third amount of data to the second information processing device and transmit a fourth amount of data to a fourth information processing device included in the plurality of information processing device, and
wherein the third edge device decreases the third amount and increases the fourth amount when a total amount of the data received by the second information processing device is larger than the first threshold and a total amount of the data received by the fourth information processing device is smaller than a third threshold, when the second edge device decreases the first amount.

5. The information processing system according to claim 2,
wherein the system further includes the second information processing device that, when an amount of the data transmitted from each of the two or more edge devices to the second information processing device is changed due to the failure, transmits, to the plurality of edge devices, information indicating a total amount of the data received by the second information processing device after the change.

6. The information processing system according to claim 5, wherein
the second information processing device is further configured to:
receive, from each of the two or more edge devices, information on a correction plan for an amount of the data transmitted from each of the two or more edge devices to the second information processing device, and
determine the changed amount of the data transmitted from each of the two or more edge devices to the second information processing device based on the information on the correction plan received from each of the two or more edge devices.

7. An edge device included in a plurality of edge devices included in an information processing system which includes a plurality of information processing devices, the information processing system being configured to process data acquired by each of the plurality of edge devices in two or more information processing devices in a distributed manner, the edge device comprising:
a communicator configured to transmit a first amount of data to a first information processing device included in the plurality of devices, and transmit a second amount of data to a second information processing device included in the plurality of information processing device; and
a processor configured to decrease the first amount and increase the second amount when detecting that a total amount of the data transmitted to the second information processing device increases due to the failure.

8. The edge device according to claim 7, wherein
the communicator receives, from the first information processing device, information indicating a total amount of the data received by the first information processing device from two or more edge devices included in the plurality of edge devices.

9. The edge device according to claim 7, wherein
the processor decreases the first amount and increases the second amount when a total amount of the data received by the first information processing device is larger than a first threshold and a total amount of the data received by the second information processing device is smaller than a second threshold.

10. An information processing device included in a plurality of information processing devices included in an information processing system which includes a plurality of edge devices, the information processing system being configured to process data acquired by each of the plurality of edge devices in two or more information processing devices in a distributed manner, the information device comprising:
a communicator configured to receive information indicating total amount of the data transmitted to the information device by each of the two or more edge devices included in the plurality of edge devices which transmit the data to the information devices and another information device included in the plurality of information devices; and
a processor configured to notify, when the total amount of the data transmitted to each of the two or more edge devices is changed due to the failure of the another information processing devices, the plurality of edge devices of a total amount of the data received by the information device.

11. The information processing device edge device according to claim 10, wherein
the communicator receives, from each of the two or more edge devices, information on a correction plan for an amount of the data transmitted from each of the two or more edge devices to the information processing device, and
the processor determines the changed amount of the data transmitted from each of the two or more edge devices to the information processing device based on the information on the correction plan received from each of the two or more edge devices.
